(19) United States
(12) Patent Application Publication
(10) Pub. No.: US 2013/0034054 A1
(43) Pub. Date: Feb. 7, 2013

(54) METHOD AND SYSTEM FOR FORMATTING CYCLIC PREFIX/POSTFIX IN A MOBILE COMMUNICATION SYSTEM

(71) Applicants: Huan Wu, Ottawa (CA); Yongkang Jia, Ottawa (CA); Yan Xin, Ottawa (CA); Shouxing Qu, Ottawa (CA); Eswar Kalyan Vutukuri, Hedge End (GB); Michael Eoin Buckley, Grayslake, IL (US)

(72) Inventors: Huan Wu, Ottawa (CA); Yongkang Jia, Ottawa (CA); Yan Xin, Ottawa (CA); Shouxing Qu, Ottawa (CA); Eswar Kalyan Vutukuri, Hedge End (GB); Michael Eoin Buckley, Grayslake, IL (US)

(21) Appl. No.: 13/577,049

(22) PCT Filed: Aug. 4, 2011
(86) PCT No.: PCT/US2011/046638

§ 371 Date: Aug. 3, 2012

(51) Int. Cl. H04W 40/00

(52) U.S. Cl. 370/328

(57) ABSTRACT

A method and transmitter, the method generating a burst containing a first data portion and a second data portion surrounding a training sequence; and appending to the burst a cyclic prefix and a cyclic postfix. Further a receiver on a network element, the receiver configured to: receive a burst containing a cyclic prefix, a cyclic postfix and a data portion; remove at least one of the cyclic prefix or the cyclic postfix; transform the data portion with a discrete Fourier transform; estimate the channel frequency response and modulation of the burst; undo an effect of a channel on the data portion by using the estimated channel frequency response of the channel on the transformed data; use an inverse discrete Fourier transform on the result of the equalizing step; and further process the output of the equalization step to decode the transmitted bits.

### FIELD OF THE DISCLOSURE

The present disclosure relates to signaling between a network and a mobile device and in particular relates to the encoding of the signaling between the network and the mobile device.

### BACKGROUND

A general packet radio service (GPRS) is a packet service on the global system for mobile communications (GSM). The service is designed to transfer packet data between a mobile station and network and has predefined data transfer rates. GPRS is a standard maintained by the third generation partnership project (3GPP) and is defined, for example, in the following technical standards: 3GPP “Layer 1, General Requirements”, TS 44.004 v. 9.0.0, Dec. 18, 2000; 3GPP “General Packet Radio Service (GPRS); Mobile Station (MS)—Base Station System (BSS) interface; Radio Link Control/Medium Access Control (RLC/MAC) protocol” TS 44.060, v.10.3.0, Dec. 22, 2010; 3GPP “General Packet Radio Service (GPRS); Overall description of the GPRS radio interface; Stage 2”, TS 43.064, v.10.0.0, Oct. 1, 2010; 3GPP, “Physical layer on the radio path; General description”, TS 45.001, v.9.3.0, Oct. 1, 2010; 3GPP, “Multiplexing and multiple access on the radio path TS 45.002, v.9.4.0, Oct. 1, 2010; 3GPP “Channel Coding”, TS 45.003, v.9.0.0, Oct. 18, 2009; and 3GPP, “Modulation” TS 45.004, v.9.1.0, Jun. 18, 2010, the contents of all of which are incorporated herein by reference.

Enhanced general packet radio service (EGPRS) is a 3GPP rel-99 feature that enhances GSM data rates by introducing 8 Phase Shift Keying (8-PSK) modulation and adaptive modulation coding schemes (MCS) with incremental redundancy. Further, evolved EGPRS (EGPRS2) is a 3GPP rel-7 feature and can double the peak data rates of EGPRS by adopting higher order modulations such as 16-Quadrature Amplitude Modulation (16-QAM) and 32-QAM, along with higher symbol rate (e.g. 325 ksymb/s) (HSR) and turbo codes. Further, 16 additional modulation encoding schemes, DAS-5 to DAS-12 and DBS-5 to DBS-12 are defined for EGPRS2 downlink radio blocks carrying radio link control (RLC) data blocks, as for example described in 3GPP TS 43.064.

GPRS, EGPRS and EGPRS2 have a predefined burst format. In particular, the burst format has a training sequence in the middle and data, header, uplink state flag (USF), stealing flag information, and tail symbols are added to the rest of the burst. The training sequence in the middle is known in advance to both the transmitter and the receiver. For transmission in the direction from the network to the mobile (referred to as downlink hereafter), legacy mobile devices operating under GPRS, EGPRS, EGPRS2A and EGPRS2B can use the known training sequence in the middle of the burst to estimate the mobile radio channel and, using the knowledge of the estimated channel, equalize or undo the impact of the radio channel on the rest of the burst and decode the data, header, USF and stealing flag information.

The USF allows multiplexing mobile stations on the same packet downlink channel (PDCH), or time slot and absolute radio-frequency channel number (ARFCN). During the establishment of an uplink temporary block flow (TBF) the mobile device is assigned a USF for each time slot in its assignment. The network indicates on a downlink radio block, in the preceding radio block period, which terminal, amongst the terminals sharing the same PDCH, is allowed to transmit in the following radio block period on the corresponding uplink timeslot of the current radio block period. In other words, the network signals to all mobile devices that are multiplexed together which mobile device is allowed to communicate in the next timeslot. Therefore, in order to allow full multiplexing of all mobile devices in the assigned uplink TBF on a given PDCH, in each downlink radio block on that PDCH, at least the USF should be encoded in such a way that it can be decoded by the mobile device to which the uplink in the next radio block period is assigned.

Similarly, piggy backed acknowledgement/negative acknowledgement (PAN) may be signaled to a device separate from the data. A PAN in a downlink radio block indicates whether the radio blocks transmitted in the uplink have been received properly by the network or not. Just like USF, the PAN could be in some embodiments addressed to a different mobile than the data in the downlink radio block.

Multiplexing using the above structure means that, in some cases, the network may transmit a USF and PAN intended for one mobile device and data for a different mobile device in the same downlink radio block. The two mobile devices may support different capabilities in some embodiments.

Precoded EGPRS2 is a study item in 3GPP GERAN investigating enhancements to EGPRS2 throughput mainly in downlink using multicarrier OFDM like techniques. With the introduction of precoded EGPRS2 (PCE2), legacy devices may be unable to decode the data, PAN and USF from the downlink bursts and hence cannot determine whether the previous uplink transmission is successful and which uplink timeslot is to be used for transmission. Further, PCE2 being an OFDM technique also results in a significant increase in the peak to average power ratio (PAPR) of the transmitted signal compared to EGPRS2 due to the introduction of an inverse discrete Fourier transformer (IDFT) precoder. Further, PCE2 also introduces additional processing functions at a transmitter, which may not be compatible with legacy equipment.

### BRIEF DESCRIPTION OF THE DRAWINGS

The present disclosure will be better understood with reference to the drawings, in which:

FIG. 1 is a diagram illustrating a burst format for a GPRS/EGPRS/EGPRS2-A burst;

FIG. 2 is a diagram illustrating a burst format for an EGPRS2-B burst;

FIG. 3 is a diagram illustrating a proposed burst format for a PCE2-A burst;

FIG. 4 is a diagram illustrating a proposed burst format for a PCE2-B burst;

FIG. 5 is a block diagram of an example transmitter for a PCE2 burst;

FIG. 6 is a timing diagram showing an uplink state flag within downlink data for transmitting on uplink resources;

FIG. 7 is a diagram illustrating a burst format for an SCE2-A(Type 1-1) burst;

FIG. 8 is a diagram illustrating a burst format for an SCE2-B(Type 1-1) burst;

FIG. 9 is a diagram illustrating an alternative burst format for an SCE2-A(Type 1-2) burst;

FIG. 10 is a diagram illustrating an alternative burst format for an SCE2-B(Type 1-2) burst;

FIG. 11 is a diagram illustrating a further alternative burst format for an SCE2-A(Type 1-3) burst;

FIG. 12 is a diagram illustrating a further alternative burst format for an SCE2-B(Type 1-3) burst;

FIG. 13 is a diagram illustrating a burst format for an SCE2-A(Type 2-1) burst;

FIG. 14 is a diagram illustrating a burst format for an SCE2-B(Type 2-1) burst;

FIG. 15A is a diagram illustrating a burst format for an SCE2-A(Type 2-2) burst;

FIG. 15B is a diagram illustrating the burst of FIG. 15A as seen at a legacy receiver;

FIG. 15C is a diagram illustrating the burst of FIG. 15A as seen at an SCE2 receiver;

FIG. 16A is a diagram illustrating a burst format for an SCE2-B(Type 2-2) burst;

FIG. 16B is a diagram illustrating the burst of FIG. 16A as seen at a legacy receiver;

FIG. 16C is a diagram illustrating the burst of FIG. 16A as seen at an SCE2 receiver;

FIG. 17 is a diagram illustrating a burst format for a variant of a PCE2-A burst where a training sequence is added and cyclic prefix and postfix are inserted;

FIG. 18 is a diagram illustrating a burst format for a variant of a PCE2-B burst where a training sequence is added and cyclic prefix and postfix are inserted;

FIG. 19 is a block diagram of an example transmitter for an SCE2 burst;

FIG. 20 is a block diagram of an alternative example transmitter for an SCE2 burst;

FIG. 21 is an example receiver for use with bursts transmitted utilizing the transmitter of FIG. 19;

FIG. 22 is an example receiver for use with bursts transmitted utilizing the transmitter of FIG. 20;

FIG. 23 is an example network architecture diagram illustrating an environment where the present systems and methods can be used; and

FIG. 24 is a block diagram of an example mobile device capable of being used with the present systems and methods.

### DETAILED DESCRIPTION OF THE DRAWINGS

The present disclosure provides a method comprising: generating, at a transmitter, a burst containing a first data portion and a second data portion surrounding a training sequence; and appending to the burst a cyclic prefix and a cyclic postfix.

The present disclosure further provides a transmitter comprising: a processor; and a communications subsystem, wherein the processor and communications subsystem cooperate to: generate a burst containing a first data portion and a second data portion surrounding a training sequence; and append to the burst a cyclic prefix and a cyclic postfix.

The present disclosure still further provides a method at a receiver comprising: receiving a burst containing a cyclic prefix and postfix and a data portion; removing the cyclic prefix or postfix; transforming the data portion with a discrete Fourier transform; estimating the modulation of the received burst and estimating the channel frequency response; and undoing an effect of a channel on the data portion by using the estimated channel frequency response of the channel on the transformed data; using an inverse discrete Fourier transform on the result of the equalizing step; and further processing the output of the equalization step to decode the transmitted bits.

The present disclosure still further provides a receiver on a network element, the receiver configured to: receive a burst containing a cyclic prefix and postfix and a data portion; remove the cyclic prefix or postfix; transform the data portion with a discrete Fourier transform; estimate the channel frequency response and modulation of the burst; and undo an effect of a channel on the data portion by using the estimated channel frequency response of the channel on the transformed data; use an inverse discrete Fourier transform on the result of the equalizing step; and further process the output of the equalization step to decode the transmitted bits.

The present disclosure still further provides a method comprising generating, at a transmitter, a burst containing a plurality of inverse discrete Fourier transform (‘IDFT’) precoded symbols surrounding a plurality of non-IDFT precoded mid-amble symbols; and adding a plurality of cyclic prefix symbols in front of the IDFT precoded symbols and a plurality of cyclic postfix symbols at an end of the IDFT precoded symbols, wherein the cyclic prefix symbols are selected from the end of the IDFT precoded symbols and cyclic postfix symbols are selected from a beginning of the IDFT precoded symbols.

The present disclosure still further provides a transmitter comprising: a processor; and a communications subsystem, wherein the processor and communications subsystem cooperate to: generate a burst containing a plurality of inverse discrete Fourier transform (‘IDFT’) precoded symbols surrounding a plurality of non-IDFT precoded mid-amble symbols; and add a plurality of cyclic prefix symbols in front of the IDFT precoded symbols and a plurality of cyclic postfix symbols at an end of the IDFT precoded symbols, the cyclic prefix symbols being selected from the end of the IDFT precoded symbols and cyclic postfix symbols are selected from a beginning of the IDFT precoded symbols.

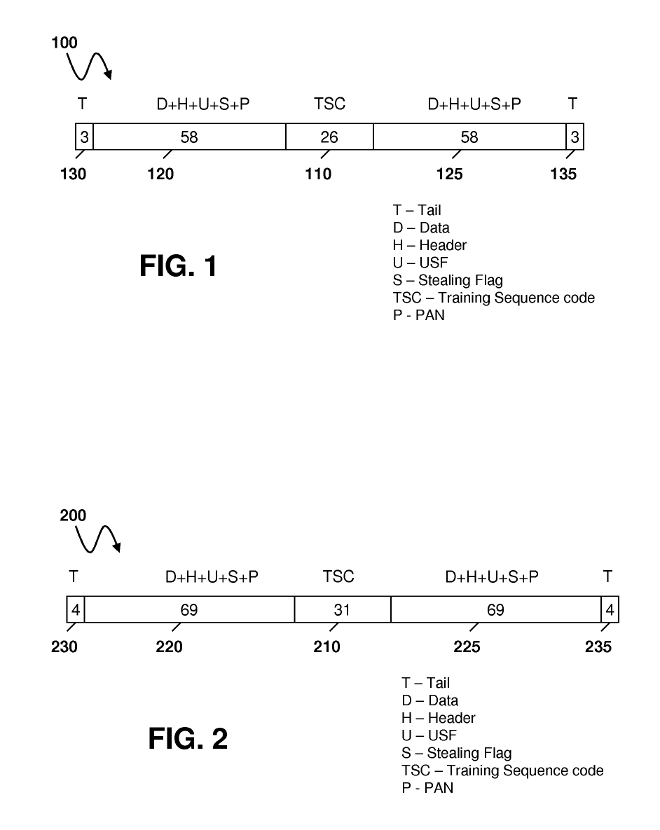

Reference is now made to FIG. 1. FIG. 1 shows a burst format for GPRS/EGPRS/EGPRS2-A, showing the format and number of symbols used for such burst format.

In FIG. 1, the burst 100 includes a training sequence code (TSC) 110, which is comprised of 26 symbols. TSC is used to train a receiver regarding channel conditions and the TSC sequence is known to both the transmitter and receiver. A total of 4 such bursts constitute one radio block. As used herein, a transmitter is any device or apparatus (or combination of devices) used for transmission. Similarly, a receiver is any device or combination of devices used for reception.

On either side of TSC 110, data+header+USF+stealing flag+PAN sections 120 and 125 are added. Sections 120 and 125 are 58 symbols each, and include a data portion that contains the coded radio link control (RLC) or medium access control (MAC) data block, which is referred to as “data” in the figures.

The USF in sections 120 and 125 controls the multiplexing of the resources in the uplink. Specifically, the USF allows the network to schedule a particular mobile device among the mobiles using the same PDCH to use the uplink in the next radio block period. During the establishment of the uplink temporary block flow, every mobile is assigned a USF for each time slot in its assignment.

The header in sections 120 and 125 contains information needed for decoding the data block and also some higher layer information. For instance, the header can contain information for controlling the hybrid automatic repeat request (HARQ) retransmissions and information on which modulation and coding scheme is used for coding of the data, among others.

The stealing flag information in sections 120 and 125 represents stealing flag bits that are used to indicate the header format. The header format needs to be known for the mobile to be able to decode the header and hence the data.

In addition to the header, data, USF and stealing flag bits, a burst may also in some embodiments carry the piggy backed acknowledgement/negative acknowledgement (PAN) information. A PAN in downlink radio block indicates whether the radio blocks transmitted by a mobile device in the uplink have been received without errors by the network or not. Just like USF, the PAN could, in some embodiments, be addressed to a different mobile than the data in the downlink radio block.

Tail bits 130 and 135 are added at the beginning of block 120 and end of block 125 respectively. Tail bits 130 and 135 are a known sequence of symbols and are used in some receiver implementations for certain signal processing steps. In the embodiment of FIG. 1, tails 130 and 135 are each 3 symbols.

Referring to FIG. 2, FIG. 2 shows the burst format for the EGPRS2-B burst format. EGPRS2-B uses a higher symbol rate than the GPRS/EGPRS/EGPRS2-A format. The symbol rate used in EGPRS2-B is 325 ksym/s whereas the symbol rate used in EGPRS2-A is 1625/6 ksym/s. Thus a burst 200 for EGPRS2-B is similar to a burst 100 from FIG. 1, with the exception that each section contains more symbols.

Referring to FIG. 2, TSC 210 of burst 200 comprises 31 symbols. Each of the data+header+USF+stealing flag sections 220 and 225 contains 69 symbols. Tails 230 and 235 contain 4 symbols.

Both FIG. 1 and FIG. 2 represent burst formats in the downlink direction. The burst formats in uplink (from a mobile device to the network) are similar to the burst formats shown in FIG. 1 and FIG. 2. However, in the uplink, there is no USF field.

### Precoded EGPRS2

One ongoing study item in 3GPP GERAN is precoded ESPRS2 (PCE2), which was, for example, proposed in the 3GPP technical standards group and published in a paper by Telefon AB LM Ericsson, GP-101066 “Precoded EGPRS Downlink (Update of GP-100918)”, GERAN #46, May 17 to 21, 2010.

PCE2 is a new feature and aims to improve link level performance of EGPRS2. The gain in performance results in improved coverage and throughput by combating the negative effects of inter-symbol interference through the application of an inverse discrete Fourier transform (IDFT) precoding technique and cyclic prefix techniques allowing the receiver to employ the Discrete Fourier Transform (DFT) and equalization in the frequency domain to eliminate the ISI. As a result, the equalization is simplified by using a single tap equalizer for each sub-carrier in the frequency domain and its performance is improved by eliminating the channel truncation and approximations needed in time domain equalizers.

It is likely that two levels of PCE2 will be defined, as was done for EGPRS2. These levels will be referred to as PCE2-A and PCE2-B throughout the present disclosure. When used herein, PCE2 could refer to either or both of PCE2-A or PCE2-B. Like EGPRS2-A, PCE2-A uses the normal symbol rate and, like EGPRS2-B, PCE2-B uses a higher symbol rate. Compared to EGPRS2, PCE2 is expected to simplify the channel estimation and equalization procedures at the receiver and is expected to have a better performance, especially for higher order modulations. PCE2 may also reduce the receiver complexity. PCE2 is likely to preserve most of the channel coding details for the modulation and coding schemes (MCSs) specified in EGPRS2, except for DAS-12 and DBS-12.

Hereafter, the mobiles not supporting PCE2, i.e., GPRS, EGPRS, EGPRS2-A and EGPRS2-B mobiles are referred to as legacy mobiles.

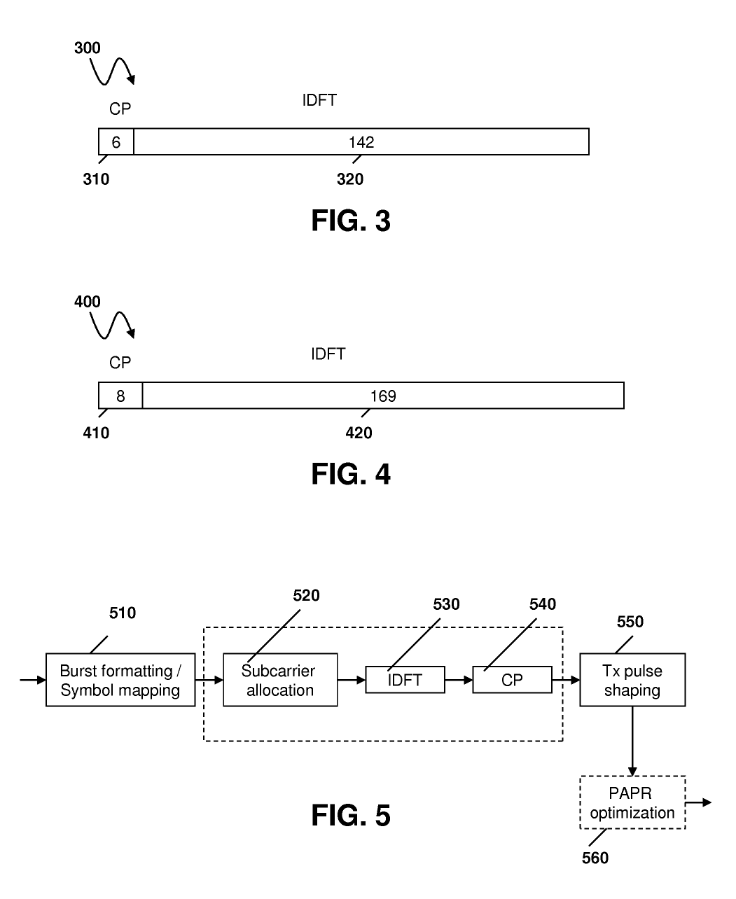

Reference is now made to FIG. 3, which shows the burst format for a PCE2-A burst. Burst 300 has a cyclic prefix 310 comprising 6 symbols, and a data portion 320 that utilizes IDFT and comprises 142 symbols. Compared to FIG. 1, it can be seen that the total number of symbols carried in a burst in FIG. 3 are the same as that in FIG. 1. The 2 tail symbol blocks 130 and 135 in FIG. 1 are now lumped into one cyclic prefix block of 6 symbols 310 in FIG. 3.

Similarly, referring to FIG. 4, a burst format for a PCE2-B burst is shown. Burst 400 contains a cyclic prefix 410 having 8 symbols, and a data portion 420 having 177 symbols. Compared to FIG. 2, it can be seen that the total number of symbols carried in a burst in FIG. 4 are the same as that in FIG. 2. The 2 tail symbol blocks 230 and 235 in FIG. 2 are now lumped into one cyclic prefix block of 8 symbols 410 in FIG. 4.

The IDFT precoding in bursts 300 and 400 results in a burst format similar to the well known orthogonal frequency divisional multiplexing (OFDM) technique. To mitigate the negative effect of inter-symbol interference on the IDFT precoded block, a cyclic prefix is appended to every IDFT (precoded) block. To achieve this, a number of symbols from the end of the IDFT precoded block are copied and arranged in front of that block. These copied symbols constitute the cyclic prefix.

Reference is made to FIG. 5, which shows a block diagram of a PCE2 transmitter. As seen in FIG. 5, the burst formatting and symbol mapping block 510 provides an output to a sub-carrier allocation block 520. The sub-carrier allocation block 520 in FIG. 5 is used to interleave the channel coded bits, which includes the data USF, SB, header, PAN and modulated training symbols.

The output from sub-carrier allocation block 520 is provided to IDFT block 530. After the inverse discrete Fourier transform is performed the output is sent to block 540, which adds the cyclic prefix.

After adding the cyclic prefix the signal is pulse shaped, as shown by block 550. Pulse shaping limits the spectrum of the transmitted signal to be within the specified boundaries.

Blocks 520, 530 and 540 are additional processes for PCE2 when compared with EGPRS2. The training symbols are spread throughout the whole frequency band to function as pilot signals for channel estimation.

Compared to EGPRS2, PCE2 has advantages due to its ability in eliminating ISI in a better and simpler way with CP insertion and the equalization in the frequency domain. At the receiver, complexity may be reduced and link performance can be improved, especially for higher order modulations with or without higher symbol rates. For backward compatibility, PCE2 generally preserves most of the modulation encoding schemes already specified in EGPRS2.

While PCE2 offers benefits in receiver implementation and improves link performance over EGPRS2, it also introduces several problems. Specifically, these are as follows.

### High Peak to Average Power Ratio Values

Like other OFDM multi-carrier systems, one drawback of PCE2 is a significant increase of the peak to average power ratio (PAPR) values compared to EGPRS2 due to the introduction of the IDFT precoder at the transmitter. The high PAPR reduces the efficiency of the transmitter power amplifier and either requires a large backoff of the mean power of a signal in order for the complete signal to remain within the linear range of the power amplifier or the acceptance of distortion of the transmitted signal with the peak portions operating in the non-linear range of the power amplifier. Further, because of the high PAPR, the PCE2 may be limited to only downlink transmissions as the high back off would have a negative impact in the uplink where mobile devices are typically power limited and the high PAPR values for the uplink transmission would drain the battery more quickly.

To overcome high PAPR, a PAPR optimization block 560 may be required at a PCE2 transmitter.

### Backward Compatibility

To maximize network resource utilization and efficiency, EGPRS2 uses a radio interface in a packet switched manner. In the case of a basic transmission time interval (BTTI) duration, all mobile devices multiplexed on a given time slot receive the data on that time slot along with uplink state flag (USF) information. In order to schedule different mobile devices on the uplink, each downlink block provides an uplink state flag field in the downlink radio link control (RLC) data block header. The USF allows multiplexing mobile devices on the same time slot or packet data channel (PDCH). During the establishment of an uplink temporary block flow (TBF), the mobile device is assigned a USF for each time slot in its assignment. In the case of BTTI, in the downlink radio block in a preceding radio block period, the network indicates which terminal is allowed to transmit in the following block period on the corresponding time slot in the uplink. In other words, the network uses the USF in a particular downlink block transmitted in a particular downlink time slot to indicate which mobile device is allowed to transmit uplink data during the next radio block period in the uplink time slot with the same time slot number as the downlink time slot. It should be noted that USF grant refers to a permission to transmit on one radio block, where a radio block corresponds to a total of 4 bursts on a given timeslot number in 4 consecutive time division multiple access (TDMA) frames (e.g., for BTTI). In the case of reduced transmission time interval (RTTI) operation, the 4 bursts constituting the radio block will be transmitted within 2 TDMA frames (using 2 timeslots per TDMA frame).

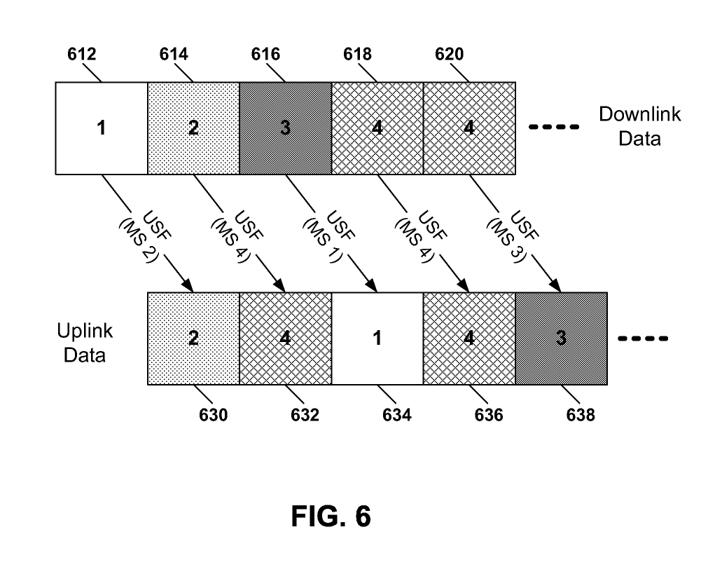

Reference is now made to FIG. 6, which shows downlink data addressed to specific mobile devices which are all in BTTI mode of operation. This illustrative example, which is not meant to be limiting, is meant to demonstrate transmission of downlink data and USF, and allocation of uplink in an exemplary scenario assuming the mobile devices and the network are capable of transmitting and receiving on all these assigned timeslots. In the illustrated example, a block of downlink data 612 is addressed to a first mobile device in a first downlink time slot of a first (e.g., current) radio block period (i.e., in the first downlink time slot of four consecutive TDMA frames making up the first radio block period). Additionally, a block of downlink data 614 is addressed to a second mobile device in a second downlink time slot of the first radio block period, a block of downlink data 616 is addressed to a third mobile device in a third downlink time slot of the first radio block period, a block of downlink data 618 is addressed to a fourth mobile device in a fourth downlink time slot of the first radio block period, and a block of downlink data 620 is addressed to the same fourth mobile device in a fifth downlink time slot of the first radio block period. The data blocks associated with the remaining three downlink time slots of the TDMA frame of the first radio block period are omitted from FIG. 6 for brevity

In addition to the data that is addressed to a specific mobile device, a block of downlink data provides a USF to indicate which mobile device is allowed to transmit during the next radio block period in the uplink time slot having the same time slot number as the downlink time slot in which the block of downlink data containing the USF was received. Thus, in FIG. 6, a USF identifying the second mobile device is provided in the block of downlink data 612 received in the first downlink time slot of the first radio block period. The second mobile device is, therefore, allowed to transmit a block of uplink data 620 in the first uplink time slot of a second (e.g., next) radio block period following the first radio block period in which the block of downlink data 612 was received. Similarly, a USF identifying the fourth mobile device is provided in the block of downlink data 614 received in the second downlink time slot of the first radio block period. The fourth mobile device is, therefore, allowed to transmit a block of uplink data 622 in the second uplink time slot of the second radio block period following the first radio block period in which the block of downlink data 614 was received.

The USF in the data block 616 received in the third downlink time slot of the first radio block period indicates that the first mobile device is allowed to transmit in the second radio block period on the third uplink time slot. Thus, the first mobile device transmits a block of uplink data 634 in the third uplink time slot of the second radio block period, as shown. Similarly, the USFs received in blocks of downlink data 618 and 620 indicate that the fourth mobile device may communicate a block of uplink data 636 in the fourth uplink time slot of the second radio block period, and the third mobile device may communicate a block of uplink data 638 in the fifth uplink time slot of the second radio block period.

Therefore, in each downlink radio block, the data may be addressed to one mobile device and the USF (granting the uplink of the next radio block period) may be addressed to the same or a different mobile device. Accordingly, the USF should be encoded in such a way that it can be decoded by the mobile device to which the uplink for the next radio block period is allocated within the corresponding uplink time slot in order to allow full multiplexing of all mobile devices with assigned uplink TBFs on the time slot.

Similar principles may apply in the case of a reduced transmission time interval (RTTI) configuration where mobile devices are multiplexed on a given time slot or PDCH pair. In this case, the USF can either be decoded in BTTI USF mode or in RTTI USF mode and indicate which RTTI radio block or blocks are allocated to a given mobile device.

Another field addressed to different mobile devices than the data is the “PAN” field used in the context of fast acknowledgement or negative acknowledgement reporting (FANR) and again the principle is that all multiplexed mobile devices should be able to decode and understand the PAN field in the downlink burst carrying data potentially for a different mobile device.

The use of a PCE2 burst in a system having legacy mobile devices incapable of reading a PCE2 burst with prevent the USF or PAN from being decoded at the legacy mobile device. The mobile device will not know which uplink is allocated. Thus the multiplexing of PAN/USF and data requires that different types of mobile devices have the same burst structure at least for the portion of a burst containing the PAN, USF or both symbols.

The use of PCE2 prevents the multiplexing with legacy mobile devices on the same time slot. This can not only lead to segregation of network resources and a reduction of throughput but also provide a barrier for adopting the PCE2 feature until a significant penetration of mobile devices supporting PCE2 is achieved.

### Additional Complexity of the Transmitter

As shown above with regard to FIG. 5, the PCE2 introduces additional processing functions at the transmitter. This increases the complexity of the base station transmit side. The main complexity lies in the additional IDFT step and potentially requires an additional PAPR optimization step. Not all base station equipment may be able to support the additional complexity without hardware upgrades and this may inhibit the adoption of PCE2 features.

### Various Solutions Proposed

Solutions such as soft clipping and hard clipping and phase rotation have been proposed in, for example, PCT Application No. PCT/US11/025614, the contents of which are incorporated herein by reference.

Further, in order to solve backwards compatibility issues, legacy burst formats may be used when transmitting the USF to legacy mobile devices or to keep the USF and the training sequence part of the downlink burst format, as provided for in U.S. Patent Application No. PCT/US11/025608, the contents of which are incorporated herein by reference.

Further, there are no specific solutions for reducing the complexity at a transmitter since the PCE2 format will require the IDFT to be implemented at the transmitter side.

Single-Carrier EGPRS2 with Cyclic Prefix/postfix (SCE2)

The present disclosure provides an alternative for EGPRS2 and PCE2. The format may be called a single-carrier EGPRS2 with a cyclic prefix/postfix and referred to herein as SCE2. As with PCE and EGPRS2, SCE2-A refers to a normal burst and SCE2-B refers to a high symbol rate burst. SCE2 is used herein to refer to either or both SCE2-A and SCE2-B.

The SCE2 burst formats retain time domain modulated data and training sequence symbols for backwards compatibility but allows an OFDM like burst structure and hence OFDM frequency domain equalization of the bursts similar to a single-carrier OFDM by appending at least one cyclic prefix. Therefore, unlike PCE2 where, in a burst, the data symbols and the training sequence symbols are multiplexed in the frequency domain, in one embodiment SCE2 utilizes data parts and training sequence in a burst format of EGPRS2 format while the two groups of tail bits are replaced with a cyclic prefix for the first half of the data part and with the cyclic postfix for the second half of the data part.

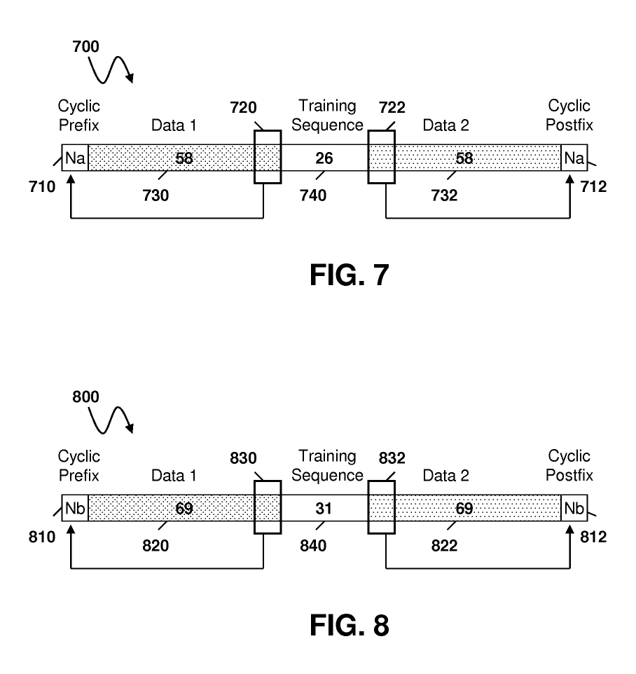

Reference is now made to FIG. 7 and FIG. 8. The addition of the cyclic prefix and postfix is equivalent to applying a DFT for each data part separately, then performing an IDFT operation to each of the DFT precoded parts and further to add a cyclic prefix and cyclic postfix. Because of the cyclic prefix and cyclic postfix, the time domain convolution of the data sequence with the channel response is cyclic and is equivalent to the frequency domain multiplication of frequency domain versions of the transmitted data sequence and the channel response.

The use of the SCE2 format allows a receiver to use a frequency domain equalizer which is much simpler than a time domain equalizer and is similar to the operation done at a PCE2 receiver. Therefore, the ISI can be eliminated in the frequency domain with a simple single tap equalizer applied to each sub carrier to equalize each received symbol.

Compared to a PCE2 receiver, the receiver of the SCE2 requires an additional IDFT after the frequency domain equalization followed by the other receiver processing steps (like channel decoding etc) to recover the transmitted data. The time domain channel estimator used in legacy EGPRS and EGPRS2 mobile devices can be re-used for SCE2 to obtain the channel impulse response and the required frequency response of the channel can be obtained by applying a Discrete Fourier Transform to the estimated channel impulse response.

The SCE2 mobile device has the same burst format as legacy EGPRS and EGPRS2 mobile devices. In one embodiment, an EGPRS and EGPRS2 mobile device can demodulate the SCE2 burst completely.

Further, higher order modulation schemes will be provided with more benefit from a frequency domain equalizer and in some embodiments lower order modulation schemes such as GMSK (Gaussian Minimum Shift Keying) may not use an SCE2 burst format but still may be part of the SCE2 mode of operation.

### SCE2 (Type 1-1)

Referring to FIG. 7, the figure shows a burst format of SCE2 (Type 1-1). In the burst format 700, a cyclic prefix 710 and cyclic postfix 712 occupy the tail portions from the EGPRS2 burst. Cyclic prefix 710 is formed from the end of the data portion 730, as shown by reference 720. Cyclic postfix 712 is formed from the beginning of data portion 732, as shown by reference 722. In FIG. 7, the length of the cyclic prefix and postfix are shown as “Na”. Na, in the present disclosure, indicates the number of symbols in a normal symbol rate cyclic prefix and postfix.

In one embodiment, since the EGPRS2 burst of FIG. 1 includes three symbols for the tail, the data taken from data portions 730 and 732, as shown by arrows 720 and 722, is also comprised of three symbols. This would make the data portions 730 and 732 equivalent in size to that of an EPGRS2 burst 100.

However, in some embodiments a channel may require a longer delay spread than three symbols. In this case a longer cyclic prefix length may be provided to eliminate inter-symbol interference as much as possible. In this case, it may be necessary to extend the cyclic prefix 710 or 712 length beyond the tail symbol lengths. In order to do this for one embodiment, a portion of the first data portion 730 and a portion of the second data portion 732 may need to be reduced in order to provide for the longer cyclic prefix but to keep the burst length the same. This can be achieved by reducing the number of data bits mapped on to each burst by using more puncturing after channel coding. In another embodiment, the cyclic prefix or postfix can be extended to the guard period and the data portions remain intact, i.e., the number of symbols in the cyclic prefix or postfix increases while the number of symbols of the guard period decreases keeping the total number of symbols in a burst unchanged.

As seen from the embodiment of FIG. 7, the training sequence 740 remains the same as an EGPRS2 burst and the length of the remaining burst is also the same. This allows for PAN and USF information to be provided to legacy devices while still providing for advantages with regard to the SCE2 burst, as described below.

The burst described with regard to FIG. 7 allows for receiver frequency domain equalizations, which need to be conducted for each of data portions 730 and 732 separately in the embodiment of FIG. 7.

Similarly, referring to FIG. 8, a burst format for an SCE2-B (Type 1-1) burst 800 is provided. In the burst, cyclic prefix 810 and cyclic prefix 812 replace the training symbols of an EGPRS2-B burst. A first data portion 820 and a second data portion 822 are provided and in the embodiment of FIG. 8, a section at the end of the first data portion 820, as shown by reference number 830 is provided as cyclic prefix 810. In FIG. 8, the length of the cyclic prefix and postfix are shown as “Nb”. Nb, in the present disclosure, indicates the number of symbols in a higher symbol rate cyclic prefix and postfix.

Similarly, a portion at the beginning of the second data portion 822, as shown by arrow 832, is provided as cyclic postfix 812.

Training sequence 840 remains the same as that of an EGPRS2-B training sequence.

The data parts and training sequence of the burst in the embodiment of FIG. 8 are the same as an EGPRS2-B burst and legacy mobile devices will therefore be able to decode the burst and receive the PAN and USF information. In the embodiment of FIG. 8, the cyclic prefix length may, in one embodiment, match the EGPRS2-B tail symbol length. Thus, in one example, the cyclic prefix length may be four symbols.

Based on the above, the bits for an SCE2 normal burst for a 16 Quadrature Amplitude Modulation (QAM) burst, where a 16QAM symbol represents 4 bits, may be as follows in Table 1:

TABLE 1
SCE2(Type 1-1) Normal Burst, 16 QAM

| Bit Number | Length of field | |
|---|---|---|
| (BN) | (bits) | Contents of field |
| 0-11 | 12 | cyclic prefix bits |
| 12-243 | 232 | encrypted bits (e0.e231) |
| 244-347 | 104 | training sequence bits |
| 348-579 | 232 | encrypted bits (e232.e463) |
| 580-591 | 12 | cyclic postfix bits |
| 592-624 | 33 | guard period |

From Table 1, the “training sequence bits” (TSC) are defined as modulating bits with states as given in Table 2 according to the training sequence code (TSC). For Broadcast Control Channel (BCCH) and Common Control Channel (CCCH), the TSC must be equal to the BCC, as defined in 3GPP TS 23.003.

TABLE 2
Training Sequence Code

| Training | |
|---|---|
| Sequence Code | |
| (TSC) | Training sequence symbols (BN244, BN245 . . . BN347) |
| 0 | (1, 1, 1, 1; 1, 1, 1, 1; 0, 0, 1, 1; 1, 1, 1, 1; 1, 1, 1, 1; 0, 0, 1, 1; 1, 1, 1, 1; 0, 0, 1, 1; 0, 0, |
| | 1, 1; 0, 0, 1, 1; 1, 1, 1, 1; 1, 1, 1, 1; 1, 1, 1, 1; 1, 1, 1, 1; 0, 0, 1, 1; 1, 1, 1, 1; 1, 1, 1, 1; |
| | 1, 1, 1, 1; 0, 0, 1, 1; 1, 1, 1, 1; 1, 1, 1, 1; 0, 0, 1, 1; 1, 1, 1, 1; 0, 0, 1, 1; 0, 0, 1, 1; 0, 0, |
| | 1, 1) |
| 1 | (1, 1, 1, 1; 1, 1, 1, 1; 0, 0, 1, 1; 1, 1, 1, 1; 0, 0, 1, 1; 0, 0, 1, 1; 1, 1, 1, 1; 0, 0, 1, 1; 0, 0, |
| | 1, 1; 0, 0, 1, 1; 1, 1, 1, 1; 0, 0, 1, 1; 0, 0, 1, 1; 0, 0, 1, 1; 0, 0, 1, 1; 1, 1, 1, 1; 1, 1, 1, 1; |
| | 1, 1, 1, 1; 0, 0, 1, 1; 1, 1, 1, 1; 0, 0, 1, 1; 0, 0, 1, 1; 1, 1, 1, 1; 0, 0, 1, 1; 0, 0, 1, 1; 0, 0, |
| | 1, 1) |
| 2 | (1, 1, 1, 1; 0, 0, 1, 1; 1, 1, 1, 1; 1, 1, 1, 1; 1, 1, 1, 1; 1, 1, 1, 1; 0, 0, 1, 1; 0, 0, 1, 1; 0, 0, |
| | 1, 1; 1, 1, 1, 1; 0, 0, 1, 1; 0, 0, 1, 1; 0, 0, 1, 1; 1, 1, 1, 1; 0, 0, 1, 1; 1, 1, 1, 1; 1, 1, 1, 1; |
| | 0, 0, 1, 1; 1, 1, 1, 1; 1, 1, 1, 1; 1, 1, 1, 1; 1, 1, 1, 1; 0, 0, 1, 1; 0, 0, 1, 1; 0, 0, 1, 1; 1, 1, |
| | 1, 1) |
| 3 | (1, 1, 1, 1; 0, 0, 1, 1; 1, 1, 1, 1; 1, 1, 1, 1; 1, 1, 1, 1; 0, 0, 1, 1; 0, 0, 1, 1; 0, 0, 1, 1; 0, 0, |
| | 1, 1; 1, 1, 1, 1; 0, 0, 1, 1; 0, 0, 1, 1; 1, 1, 1, 1; 0, 0, 1, 1; 1, 1, 1, 1; 1, 1, 1, 1; 1, 1, 1, 1; |
| | 0, 0, 1, 1; 1, 1, 1, 1; 1, 1, 1, 1; 1, 1, 1, 1; 0, 0, 1, 1; 0, 0, 1, 1; 0, 0, 1, 1; 0, 0, 1, 1; 1, 1, |
| | 1, 1) |
| 4 | (1, 1, 1, 1; 1, 1, 1, 1; 1, 1, 1, 1; 0, 0, 1, 1; 0, 0, 1, 1; 1, 1, 1, 1; 0, 0, 1, 1; 1, 1, 1, 1; 0, 0, |
| | 1, 1; 0, 0, 1, 1; 0, 0, 1, 1; 1, 1, 1, 1; 1, 1, 1, 1; 0, 0, 1, 1; 1, 1, 1, 1; 1, 1, 1, 1; 1, 1, 1, 1; |
| | 1, 1, 1, 1; 1, 1, 1, 1; 0, 0, 1, 1; 0, 0, 1, 1; 1, 1, 1, 1; 0, 0, 1, 1; 1, 1, 1, 1; 0, 0, 1, 1; 0, 0, |
| | 1, 1) |
| 5 | (1, 1, 1, 1; 0, 0, 1, 1; 1, 1, 1, 1; 1, 1, 1, 1; 0, 0, 1, 1; 0, 0, 1, 1; 0, 0, 1, 1; 1, 1, 1, 1; 0, 0, |
| | 1, 1; 1, 1, 1, 1; 0, 0, 1, 1; 0, 0, 1, 1; 1, 1, 1, 1; 1, 1, 1, 1; 1, 1, 1, 1; 1, 1, 1, 1; 1, 1, 1, 1; |
| | 0, 0, 1, 1; 1, 1, 1, 1; 1, 1, 1, 1; 0, 0, 1, 1; 0, 0, 1, 1; 0, 0, 1, 1; 1, 1, 1, 1; 0, 0, 1, 1; 1, 1, |
| | 1, 1) |
| 6 | (0, 0, 1, 1; 1, 1, 1, 1; 0, 0, 1, 1; 1, 1, 1, 1; 1, 1, 1, 1; 0, 0, 1, 1; 0, 0, 1, 1; 0, 0, 1, 1; 0, 0, |
| | 1, 1; 0, 0, 1, 1; 1, 1, 1, 1; 0, 0, 1, 1; 0, 0, 1, 1; 1, 1, 1, 1; 1, 1, 1, 1; 1, 1, 1, 1; 0, 0, 1, 1; |
| | 1, 1, 1, 1; 0, 0, 1, 1; 1, 1, 1, 1; 1, 1, 1, 1; 0, 0, 1, 1; 0, 0, 1, 1; 0, 0, 1, 1; 0, 0, 1, 1; 0, 0, |
| | 1, 1) |
| 7 | (0, 0, 1, 1; 0, 0, 1, 1; 0, 0, 1, 1; 1, 1, 1, 1; 0, 0, 1, 1; 0, 0, 1, 1; 0, 0, 1, 1; 0, 0, 1, 1; 1, 1, |
| | 1, 1; 1, 1, 1, 1; 1, 1, 1, 1; 0, 0, 1, 1; 1, 1, 1, 1; 1, 1, 1, 1; 0, 0, 1, 1; 1, 1, 1, 1; 0, 0, 1, 1; |
| | 0, 0, 1, 1; 0, 0, 1, 1; 1, 1, 1, 1; 0, 0, 1, 1; 0, 0, 1, 1; 0, 0, 1, 1; 0, 0, 1, 1; 1, 1, 1, 1; 1, 1, |
| | 1, 1) |

From Table 1, the “cyclic prefix bits” are defined as modulating bits with states as follows: (BN0, BN1 . . . BN11)=(BN232, BN233, . . . , BN243). Thus the cyclic prefix bits are the same as the 12 bits immediately preceding the training sequence and are the last 12 bits of the first data portion. Also the “cyclic postfix bits” are defined as modulating bits with states as follows: (BN580, BN581 . . . BN591)=(BN348, BN349, . . . , BN359). Thus the cyclic postfix bits are the same as the 12 bits immediately following the training sequence and are the first 12 bits of the second data portion.

Similarly, the SCE2 normal burst for a 32 QAM, where a 32 QAM symbol represents 5 bits, in accordance with FIG. 7 may be as follows in Table 3:

TABLE 3
SCE2(Type 1-1) Normal Burst, 32 QAM

| Bit Number | Length of field | |
|---|---|---|
| (BN) | (bits) | Contents of field |
| 0-14 | 15 | cyclic prefix bits |
| 15-304 | 290 | encrypted bits (e0.e289) |
| 305-434 | 130 | training sequence bits |
| 435-724 | 290 | encrypted bits (e290.e579) |
| 725-739 | 15 | cyclic postfix bits |
| 740-781 | 41.25 | guard period |

From Table 3 the “training sequence bits” are defined as modulating bits with states as given in Table 4 according to the training sequence code, TSC. For BCCH and CCCH, the TSC must be equal to the BCC, as defined in 3GPP TS 23.003.

TABLE 4
Training Sequence Code

| Training | |
|---|---|
| Sequence Code | |
| (TSC) | Training sequence symbols (BN305, BN306 . . . BN434) |
| 0 | (0, 0, 0, 0, 0; 0, 0, 0, 0, 0; 1, 0, 0, 1, 0; 0, 0, 0, 0, 0; 0, 0, 0, 0, 0; 1, 0, 0, 1, 0; 0, 0, 0, 0, |
| | 0; 1, 0, 0, 1, 0; 1, 0, 0, 1, 0; 1, 0, 0, 1, 0; 0, 0, 0, 0, 0; 0, 0, 0, 0, 0; 0, 0, 0, 0, 0; 0, 0, 0, |
| | 0, 0; 1, 0, 0, 1, 0; 0, 0, 0, 0, 0; 0, 0, 0, 0, 0; 0, 0, 0, 0, 0; 1, 0, 0, 1, 0; 0, 0, 0, 0, 0; 0, 0, |
| | 0, 0, 0; 1, 0, 0, 1, 0; 0, 0, 0, 0, 0; 1, 0, 0, 1, 0; 1, 0, 0, 1, 0; 1, 0, 0, 1, 0) |
| 1 | (0, 0, 0, 0, 0; 0, 0, 0, 0, 0; 1, 0, 0, 1, 0; 0, 0, 0, 0, 0; 1, 0, 0, 1, 0; 1, 0, 0, 1, 0; 0, 0, 0, 0, |
| | 0; 1, 0, 0, 1, 0; 1, 0, 0, 1, 0; 1, 0, 0, 1, 0; 0, 0, 0, 0, 0; 1, 0, 0, 1, 0; 1, 0, 0, 1, 0; 1, 0, 0, |
| | 1, 0; 1, 0, 0, 1, 0; 0, 0, 0, 0, 0; 0, 0, 0, 0, 0; 0, 0, 0, 0, 0; 1, 0, 0, 1, 0; 0, 0, 0, 0, 0; 1, 0, |
| | 0, 1, 0; 1, 0, 0, 1, 0; 0, 0, 0, 0, 0; 1, 0, 0, 1, 0; 1, 0, 0, 1, 0; 1, 0, 0, 1, 0) |
| 2 | (0, 0, 0, 0, 0; 1, 0, 0, 1, 0; 0, 0, 0, 0, 0; 0, 0, 0, 0, 0; 0, 0, 0, 0, 0; 0, 0, 0, 0, 0; 1, 0, 0, 1, |
| | 0; 1, 0, 0, 1, 0; 1, 0, 0, 1, 0; 0, 0, 0, 0, 0; 1, 0, 0, 1, 0; 1, 0, 0, 1, 0; 1, 0, 0, 1, 0; 0, 0, 0, |
| | 0, 0; 1, 0, 0, 1, 0; 0, 0, 0, 0, 0; 0, 0, 0, 0, 0; 1, 0, 0, 1, 0; 0, 0, 0, 0, 0; 0, 0, 0, 0, 0; 0, 0, |
| | 0, 0, 0; 0, 0, 0, 0, 0; 1, 0, 0, 1, 0; 1, 0, 0, 1, 0; 1, 0, 0, 1, 0; 0, 0, 0, 0, 0) |
| 3 | (0, 0, 0, 0, 0; 1, 0, 0, 1, 0; 0, 0, 0, 0, 0; 0, 0, 0, 0, 0; 0, 0, 0, 0, 0; 1, 0, 0, 1, 0; 1, 0, 0, 1, |
| | 0; 1, 0, 0, 1, 0; 1, 0, 0, 1, 0; 0, 0, 0, 0, 0; 1, 0, 0, 1, 0; 1, 0, 0, 1, 0; 0, 0, 0, 0, 0; 1, 0, 0, |
| | 1, 0; 0, 0, 0, 0, 0; 0, 0, 0, 0, 0; 0, 0, 0, 0, 0; 1, 0, 0, 1, 0; 0, 0, 0, 0, 0; 0, 0, 0, 0, 0; 0, 0, |
| | 0, 0, 0; 1, 0, 0, 1, 0; 1, 0, 0, 1, 0; 1, 0, 0, 1, 0; 1, 0, 0, 1, 0; 0, 0, 0, 0, 0) |
| 4 | (0, 0, 0, 0, 0; 0, 0, 0, 0, 0; 0, 0, 0, 0, 0; 1, 0, 0, 1, 0; 1, 0, 0, 1, 0; 0, 0, 0, 0, 0; 1, 0, 0, 1, |
| | 0; 0, 0, 0, 0, 0; 1, 0, 0, 1, 0; 1, 0, 0, 1, 0; 1, 0, 0, 1, 0; 0, 0, 0, 0, 0; 0, 0, 0, 0, 0; 1, 0, 0, |
| | 1, 0; 0, 0, 0, 0, 0; 0, 0, 0, 0, 0; 0, 0, 0, 0, 0; 0, 0, 0, 0, 0; 0, 0, 0, 0, 0; 1, 0, 0, 1, 0; 1, 0, |
| | 0, 1, 0; 0, 0, 0, 0, 0; 1, 0, 0, 1, 0; 0, 0, 0, 0, 0; 1, 0, 0, 1, 0; 1, 0, 0, 1, 0) |
| 5 | (0, 0, 0, 0, 0; 1, 0, 0, 1, 0; 0, 0, 0, 0, 0; 0, 0, 0, 0, 0; 1, 0, 0, 1, 0; 1, 0, 0, 1, 0; 1, 0, 0, 1, |
| | 0; 0, 0, 0, 0, 0; 1, 0, 0, 1, 0; 0, 0, 0, 0, 0; 1, 0, 0, 1, 0; 1, 0, 0, 1, 0; 0, 0, 0, 0, 0; 0, 0, 0, |
| | 0, 0; 0, 0, 0, 0, 0; 0, 0, 0, 0, 0; 0, 0, 0, 0, 0; 1, 0, 0, 1, 0; 0, 0, 0, 0, 0; 0, 0, 0, 0, 0; 1, 0, |
| | 0, 1, 0; 1, 0, 0, 1, 0; 1, 0, 0, 1, 0; 0, 0, 0, 0, 0; 1, 0, 0, 1, 0; 0, 0, 0, 0, 0) |
| 6 | (1, 0, 0, 1, 0; 0, 0, 0, 0, 0; 1, 0, 0, 1, 0; 0, 0, 0, 0, 0; 0, 0, 0, 0, 0; 1, 0, 0, 1, 0; 1, 0, 0, 1, |
| | 0; 1, 0, 0, 1, 0; 1, 0, 0, 1, 0; 1, 0, 0, 1, 0; 0, 0, 0, 0, 0; 1, 0, 0, 1, 0; 1, 0, 0, 1, 0; 0, 0, 0, |
| | 0, 0; 0, 0, 0, 0, 0; 0, 0, 0, 0, 0; 1, 0, 0, 1, 0; 0, 0, 0, 0, 0; 1, 0, 0, 1, 0; 0, 0, 0, 0, 0; 0, 0, |
| | 0, 0, 0; 1, 0, 0, 1, 0; 1, 0, 0, 1, 0; 1, 0, 0, 1, 0; 1, 0, 0, 1, 0; 1, 0, 0, 1, 0) |
| 7 | (1, 0, 0, 1, 0; 1, 0, 0, 1, 0; 1, 0, 0, 1, 0; 0, 0, 0, 0, 0; 1, 0, 0, 1, 0; 1, 0, 0, 1, 0; 1, 0, 0, 1, |
| | 0; 1, 0, 0, 1, 0; 0, 0, 0, 0, 0; 0, 0, 0, 0, 0; 0, 0, 0, 0, 0; 1, 0, 0, 1, 0; 0, 0, 0, 0, 0; 0, 0, 0, |
| | 0, 0; 1, 0, 0, 1, 0; 0, 0, 0, 0, 0; 1, 0, 0, 1, 0; 1, 0, 0, 1, 0; 1, 0, 0, 1, 0; 0, 0, 0, 0, 0; 1, 0, |
| | 0, 1, 0; 1, 0, 0, 1, 0; 1, 0, 0, 1, 0; 1, 0, 0, 1, 0; 0, 0, 0, 0, 0; 0, 0, 0, 0, 0) |

From the above, the “cyclic prefix bits” are defined as modulating bits with states as follows: (BN0, BN1 . . . BN14)=(BN290, BN291, . . . , BN304), Thus the cyclic prefix bits are the same as the 15 bits immediately preceding the training sequence and are the last 15 bits of the first data portion. The “cyclic postfix bits” are defined as modulating bits with states as follows: (BN725, BN726 . . . BN739)=(BN435, BN436, . . . , BN449). Thus the cyclic postfix bits are the same as the 15 bits immediately following the training sequence and are the first 15 bits of the second data portion.

For the embodiment of FIG. 8, the SCE2 for the higher symbol rate burst for 16 QAM, where a 16 QAM symbol represents 4 bits, may include the format of Table 5:

TABLE 5
SCE2(Type 1-1) High Symbol Rate Burst, 16 QAM

| Bit Number | Length of field | |
|---|---|---|
| (BN) | (bits) | Contents of field |
| 0-15 | 16 | cyclic prefix bits |
| 16-291 | 276 | encrypted bits (e0.e275) |
| 292-415 | 124 | training sequence bits |
| 416-691 | 276 | encrypted bits (e276.e551) |
| 692-707 | 16 | cyclic postfix bits |
| 708-749 | 42 | guard period |

From Table 5, the “training sequence bits” are defined as modulating bits with states as given in Table 6 according to the training sequence code, TSC. For BCCH and CCCH, the TSC must be equal to the BCC, as defined in 3GPP TS 23.003.

TABLE 6
Training Sequence Code

| Training | |
|---|---|
| Sequence Code | |
| (TSC) | Training sequence symbols (BN292, BN293 . . . BN415) |
| 0 | (0, 0, 1, 1; 1, 1, 1, 1; 0, 0, 1, 1; 0, 0, 1, 1; 1, 1, 1, 1; 0, 0, 1, 1; 0, 0, 1, 1; 0, 0, 1, 1; 1, 1, |
| | 1, 1; 0, 0, 1, 1; 1, 1, 1, 1; 1, 1, 1, 1; 1, 1, 1, 1; 1, 1, 1, 1; 1, 1, 1, 1; 1, 1, 1, 1; 1, 1, 1, 1; |
| | 0, 0, 1, 1; 0, 0, 1, 1; 1, 1, 1, 1; 0, 0, 1, 1; 1, 1, 1, 1; 1, 1, 1, 1; 1, 1, 1, 1; 1, 1, 1, 1; 0, 0, |
| | 1, 1; 0, 0, 1, 1; 1, 1, 1, 1; 1, 1, 1, 1; 1, 1, 1, 1; 0, 0, 1, 1) |
| 1 | (1, 1, 1, 1; 1, 1, 1, 1; 1, 1, 1, 1; 0, 0, 1, 1; 0, 0, 1, 1; 1, 1, 1, 1; 1, 1, 1, 1; 0, 0, 1, 1; 0, 0, |
| | 1, 1; 0, 0, 1, 1; 1, 1, 1, 1; 1, 1, 1, 1; 1, 1, 1, 1; 1, 1, 1, 1; 1, 1, 1, 1; 0, 0, 1, 1; 1, 1, 1, 1; |
| | 0, 0, 1, 1; 1, 1, 1, 1; 1, 1, 1, 1; 0, 0, 1, 1; 1, 1, 1, 1; 0, 0, 1, 1; 0, 0, 1, 1; 0, 0, 1, 1; 1, 1, |
| | 1, 1; 0, 0, 1, 1; 0, 0, 1, 1; 1, 1, 1, 1; 0, 0, 1, 1; 0, 0, 1, 1) |
| 2 | (1, 1, 1, 1; 0, 0, 1, 1; 0, 0, 1, 1; 1, 1, 1, 1; 1, 1, 1, 1; 1, 1, 1, 1; 0, 0, 1, 1; 1, 1, 1, 1; 1, 1, |
| | 1, 1; 1, 1, 1, 1; 0, 0, 1, 1; 0, 0, 1, 1; 1, 1, 1, 1; 0, 0, 1, 1; 1, 1, 1, 1; 1, 1, 1, 1; 0, 0, 1, 1; |
| | 1, 1, 1, 1; 1, 1, 1, 1; 1, 1, 1, 1; 1, 1, 1, 1; 1, 1, 1, 1; 0, 0, 1, 1; 0, 0, 1, 1; 0, 0, 1, 1; 1, 1, |
| | 1, 1; 0, 0, 1, 1; 1, 1, 1, 1; 0, 0, 1, 1; 0, 0, 1, 1; 0, 0, 1, 1) |
| 3 | (0, 0, 1, 1; 0, 0, 1, 1; 0, 0, 1, 1; 0, 0, 1, 1; 1, 1, 1, 1; 1, 1, 1, 1; 1, 1, 1, 1; 0, 0, 1, 1; 0, 0, |
| | 1, 1; 0, 0, 1, 1; 0, 0, 1, 1; 0, 0, 1, 1; 0, 0, 1, 1; 1, 1, 1, 1; 0, 0, 1, 1; 0, 0, 1, 1; 1, 1, 1, 1; |
| | 1, 1, 1, 1; 1, 1, 1, 1; 0, 0, 1, 1; 1, 1, 1, 1; 0, 0, 1, 1; 1, 1, 1, 1; 1, 1, 1, 1; 0, 0, 1, 1; 0, 0, |
| | 1, 1; 1, 1, 1, 1; 0, 0, 1, 1; 1, 1, 1, 1; 0, 0, 1, 1; 0, 0, 1, 1) |
| 4 | (1, 1, 1, 1; 0, 0, 1, 1; 1, 1, 1, 1; 0, 0, 1, 1; 0, 0, 1, 1; 1, 1, 1, 1; 1, 1, 1, 1; 1, 1, 1, 1; 0, 0, |
| | 1, 1; 0, 0, 1, 1; 0, 0, 1, 1; 1, 1, 1, 1; 1, 1, 1, 1; 0, 0, 1, 1; 1, 1, 1, 1; 1, 1, 1, 1; 0, 0, 1, 1; |
| | 0, 0, 1, 1; 1, 1, 1, 1; 0, 0, 1, 1; 1, 1, 1, 1; 1, 1, 1, 1; 1, 1, 1, 1; 1, 1, 1, 1; 1, 1, 1, 1; 1, 1, |
| | 1, 1; 1, 1, 1, 1; 0, 0, 1, 1; 1, 1, 1, 1; 0, 0, 1, 1; 0, 0, 1, 1) |
| 5 | (0, 0, 1, 1; 0, 0, 1, 1; 1, 1, 1, 1; 0, 0, 1, 1; 1, 1, 1, 1; 0, 0, 1, 1; 0, 0, 1, 1; 1, 1, 1, 1; 1, 1, |
| | 1, 1; 0, 0, 1, 1; 1, 1, 1, 1; 0, 0, 1, 1; 1, 1, 1, 1; 1, 1, 1, 1; 1, 1, 1, 1; 0, 0, 1, 1; 0, 0, 1, 1; |
| | 1, 1, 1, 1; 0, 0, 1, 1; 0, 0, 1, 1; 0, 0, 1, 1; 0, 0, 1, 1; 0, 0, 1, 1; 0, 0, 1, 1; 1, 1, 1, 1; 1, 1, |
| | 1, 1; 1, 1, 1, 1; 0, 0, 1, 1; 0, 0, 1, 1; 0, 0, 1, 1; 0, 0, 1, 1) |
| 6 | (1, 1, 1, 1; 0, 0, 1, 1; 1, 1, 1, 1; 1, 1, 1, 1; 1, 1, 1, 1; 1, 1, 1, 1; 1, 1, 1, 1; 1, 1, 1, 1; 0, 0, |
| | 1, 1; 1, 1, 1, 1; 1, 1, 1, 1; 0, 0, 1, 1; 1, 1, 1, 1; 0, 0, 1, 1; 0, 0, 1, 1; 0, 0, 1, 1; 1, 1, 1, 1; |
| | 1, 1, 1, 1; 1, 1, 1, 1; 0, 0, 1, 1; 1, 1, 1, 1; 1, 1, 1, 1; 0, 0, 1, 1; 0, 0, 1, 1; 0, 0, 1, 1; 1, 1, |
| | 1, 1; 1, 1, 1, 1; 1, 1, 1, 1; 0, 0, 1, 1; 1, 1, 1, 1; 0, 0, 1, 1) |
| 7 | (1, 1, 1, 1; 0, 0, 1, 1; 1, 1, 1, 1; 1, 1, 1, 1; 1, 1, 1, 1; 1, 1, 1, 1; 1, 1, 1, 1; 0, 0, 1, 1; 1, 1, |
| | 1, 1; 1, 1, 1, 1; 0, 0, 1, 1; 1, 1, 1, 1; 0, 0, 1, 1; 1, 1, 1, 1; 1, 1, 1, 1; 1, 1, 1, 1; 0, 0, 1, 1; |
| | 0, 0, 1, 1; 0, 0, 1, 1; 0, 0, 1, 1; 1, 1, 1, 1; 1, 1, 1, 1; 0, 0, 1, 1; 1, 1, 1, 1; 1, 1, 1, 1; 1, 1, |
| | 1, 1; 0, 0, 1, 1; 1, 1, 1, 1; 1, 1, 1, 1; 0, 0, 1, 1; 0, 0, 1, 1) |

From the above, the “cyclic prefix bits” are defined as modulating bits with states as follows: (BN0, BN1 . . . BN15)=(BN276, BN277, . . . BN291). Thus the cyclic prefix bits are the same as the 16 bits immediately preceding the training sequence and are the last twelve bits of the first data portion. The “cyclic postfix bits” are defined as modulating bits with states as follows: (BN692, BN693 . . . BN707)=(BN416, BN417, . . . BN431). Thus the cyclic prefix bits are the same as the 16 bits immediately following the training sequence and are the first 16 bits of the second data portion.

Similarly, the SCE2 for a higher symbol burst rate for 32 QAM, where a 32 QAM symbol represents 5 bits, is shown in Table 7 below:

TABLE 7
SCE2(Type 1-1) High Symbol Rate Burst, 32 QAM

| | Length of field | |
|---|---|---|
| Bit Number (BN) | (bits) | Contents of field |
| 0-19 | 20 | cyclic prefix bits |
| 20-364 | 345 | encrypted bits (e0.e344) |
| 365-519 | 155 | training sequence bits |
| 520-864 | 345 | encrypted bits (e345.e689) |
| 865-884 | 20 | cyclic postfix bits |
| 885-937 | 52.5 | guard period |

From Table 7, the “training sequence bits” are defined as modulating bits with states as given in Table 8 according to the training sequence code, TSC. For BCCH and CCCH, the TSC must be equal to the BCC, as defined in 3GPP TS 23.003.

TABLE 8
Training Sequence Code

| Training | |
|---|---|
| Sequence Code | |
| (TSC) | Training sequence symbols (BN365, BN366 . . . BN519) |
| 0 | (1, 0, 0, 1, 0; 0, 0, 0, 0, 0; 1, 0, 0, 1, 0; 1, 0, 0, 1, 0; 0, 0, 0, 0, 0; 1, 0, 0, 1, 0; 1, 0, 0, 1, |
| | 0; 1, 0, 0, 1, 0; 0, 0, 0, 0, 0; 1, 0, 0, 1, 0; 0, 0, 0, 0, 0; 0, 0, 0, 0, 0; 0, 0, 0, 0, 0; 0, 0, 0, |
| | 0, 0; 0, 0, 0, 0, 0; 0, 0, 0, 0, 0; 0, 0, 0, 0, 0; 1, 0, 0, 1, 0; 1, 0, 0, 1, 0; 0, 0, 0, 0, 0; 1, 0, |
| | 0, 1, 0; 0, 0, 0, 0, 0; 0, 0, 0, 0, 0; 0, 0, 0, 0, 0; 0, 0, 0, 0, 0; 1, 0, 0, 1, 0; 1, 0, 0, 1, 0; 0, |
| | 0, 0, 0, 0; 0, 0, 0, 0, 0; 0, 0, 0, 0, 0; 1, 0, 0, 1, 0) |
| 1 | (0, 0, 0, 0, 0; 0, 0, 0, 0, 0; 0, 0, 0, 0, 0; 1, 0, 0, 1, 0; 1, 0, 0, 1, 0; 0, 0, 0, 0, 0; 0, 0, 0, 0, |
| | 0; 1, 0, 0, 1, 0; 1, 0, 0, 1, 0; 1, 0, 0, 1, 0; 0, 0, 0, 0, 0; 0, 0, 0, 0, 0; 0, 0, 0, 0, 0; 0, 0, 0, |
| | 0, 0; 0, 0, 0, 0, 0; 1, 0, 0, 1, 0; 0, 0, 0, 0, 0; 1, 0, 0, 1, 0; 0, 0, 0, 0, 0; 0, 0, 0, 0, 0; 1, 0, |
| | 0, 1, 0; 0, 0, 0, 0, 0; 1, 0, 0, 1, 0; 1, 0, 0, 1, 0; 1, 0, 0, 1, 0; 0, 0, 0, 0, 0; 1, 0, 0, 1, 0; 1, |
| | 0, 0, 1, 0; 0, 0, 0, 0, 0; 1, 0, 0, 1, 0; 1, 0, 0, 1, 0) |
| 2 | (0, 0, 0, 0, 0; 1, 0, 0, 1, 0; 1, 0, 0, 1, 0; 0, 0, 0, 0, 0; 0, 0, 0, 0, 0; 0, 0, 0, 0, 0; 1, 0, 0, 1, |
| | 0; 0, 0, 0, 0, 0; 0, 0, 0, 0, 0; 0, 0, 0, 0, 0; 1, 0, 0, 1, 0; 1, 0, 0, 1, 0; 0, 0, 0, 0, 0; 1, 0, 0, |
| | 1, 0; 0, 0, 0, 0, 0; 0, 0, 0, 0, 0; 1, 0, 0, 1, 0; 0, 0, 0, 0, 0; 0, 0, 0, 0, 0; 0, 0, 0, 0, 0; 0, 0, |
| | 0, 0, 0; 0, 0, 0, 0, 0; 1, 0, 0, 1, 0; 1, 0, 0, 1, 0; 1, 0, 0, 1, 0; 0, 0, 0, 0, 0; 1, 0, 0, 1, 0; 0, |
| | 0, 0, 0, 0; 1, 0, 0, 1, 0; 1, 0, 0, 1, 0; 1, 0, 0, 1, 0) |
| 3 | (1, 0, 0, 1, 0; 1, 0, 0, 1, 0; 1, 0, 0, 1, 0; 1, 0, 0, 1, 0; 0, 0, 0, 0, 0; 0, 0, 0, 0, 0; 0, 0, 0, 0, |
| | 0; 1, 0, 0, 1, 0; 1, 0, 0, 1, 0; 1, 0, 0, 1, 0; 1, 0, 0, 1, 0; 1, 0, 0, 1, 0; 1, 0, 0, 1, 0; 0, 0, 0, |
| | 0, 0; 1, 0, 0, 1, 0; 1, 0, 0, 1, 0; 0, 0, 0, 0, 0; 0, 0, 0, 0, 0; 0, 0, 0, 0, 0; 1, 0, 0, 1, 0; 0, 0, |
| | 0, 0, 0; 1, 0, 0, 1, 0; 0, 0, 0, 0, 0; 0, 0, 0, 0, 0; 1, 0, 0, 1, 0; 1, 0, 0, 1, 0; 0, 0, 0, 0, 0; 1, |
| | 0, 0, 1, 0; 0, 0, 0, 0, 0; 1, 0, 0, 1, 0; 1, 0, 0, 1, 0) |
| 4 | (0, 0, 0, 0, 0; 1, 0, 0, 1, 0; 0, 0, 0, 0, 0; 1, 0, 0, 1, 0; 1, 0, 0, 1, 0; 0, 0, 0, 0, 0; 0, 0, 0, 0, |
| | 0; 0, 0, 0, 0, 0; 1, 0, 0, 1, 0; 1, 0, 0, 1, 0; 1, 0, 0, 1, 0; 0, 0, 0, 0, 0; 0, 0, 0, 0, 0; 1, 0, 0, |
| | 1, 0; 0, 0, 0, 0, 0; 0, 0, 0, 0, 0; 1, 0, 0, 1, 0; 1, 0, 0, 1, 0; 0, 0, 0, 0, 0; 1, 0, 0, 1, 0; 0, 0, |
| | 0, 0, 0; 0, 0, 0, 0, 0; 0, 0, 0, 0, 0; 0, 0, 0, 0, 0; 0, 0, 0, 0, 0; 0, 0, 0, 0, 0; 0, 0, 0, 0, 0; 1, |
| | 0, 0, 1, 0; 0, 0, 0, 0, 0; 1, 0, 0, 1, 0; 1, 0, 0, 1, 0) |
| 5 | (1, 0, 0, 1, 0; 1, 0, 0, 1, 0; 0, 0, 0, 0, 0; 1, 0, 0, 1, 0; 0, 0, 0, 0, 0; 1, 0, 0, 1, 0; 1, 0, 0, 1, |
| | 0; 0, 0, 0, 0, 0; 0, 0, 0, 0, 0; 1, 0, 0, 1, 0; 0, 0, 0, 0, 0; 1, 0, 0, 1, 0; 0, 0, 0, 0, 0; 0, 0, 0, |
| | 0, 0; 0, 0, 0, 0, 0; 1, 0, 0, 1, 0; 1, 0, 0, 1, 0; 0, 0, 0, 0, 0; 1, 0, 0, 1, 0; 1, 0, 0, 1, 0; 1, 0, |
| | 0, 1, 0; 1, 0, 0, 1, 0; 1, 0, 0, 1, 0; 1, 0, 0, 1, 0; 0, 0, 0, 0, 0; 0, 0, 0, 0, 0; 0, 0, 0, 0, 0; 1, |
| | 0, 0, 1, 0; 1, 0, 0, 1, 0; 1, 0, 0, 1, 0; 1, 0, 0, 1, 0) |
| 6 | (0, 0, 0, 0, 0; 1, 0, 0, 1, 0; 0, 0, 0, 0, 0; 0, 0, 0, 0, 0; 0, 0, 0, 0, 0; 0, 0, 0, 0, 0; 0, 0, 0, 0, |
| | 0; 0, 0, 0, 0, 0; 1, 0, 0, 1, 0; 0, 0, 0, 0, 0; 0, 0, 0, 0, 0; 1, 0, 0, 1, 0; 0, 0, 0, 0, 0; 1, 0, 0, |
| | 1, 0; 1, 0, 0, 1, 0; 1, 0, 0, 1, 0; 0, 0, 0, 0, 0; 0, 0, 0, 0, 0; 0, 0, 0, 0, 0; 1, 0, 0, 1, 0; 0, 0, |
| | 0, 0, 0; 0, 0, 0, 0, 0; 1, 0, 0, 1, 0; 1, 0, 0, 1, 0; 1, 0, 0, 1, 0; 0, 0, 0, 0, 0; 0, 0, 0, 0, 0; 0, |
| | 0, 0, 0, 0; 1, 0, 0, 1, 0; 0, 0, 0, 0, 0; 1, 0, 0, 1, 0) |
| 7 | (0, 0, 0, 0, 0; 1, 0, 0, 1, 0; 0, 0, 0, 0, 0; 0, 0, 0, 0, 0; 0, 0, 0, 0, 0; 0, 0, 0, 0, 0; 0, 0, 0, 0, |
| | 0; 1, 0, 0, 1, 0; 0, 0, 0, 0, 0; 0, 0, 0, 0, 0; 1, 0, 0, 1, 0; 0, 0, 0, 0, 0; 1, 0, 0, 1, 0; 0, 0, 0, |
| | 0, 0; 0, 0, 0, 0, 0; 0, 0, 0, 0, 0; 1, 0, 0, 1, 0; 1, 0, 0, 1, 0; 1, 0, 0, 1, 0; 1, 0, 0, 1, 0; 0, 0, |
| | 0, 0, 0; 0, 0, 0, 0, 0; 1, 0, 0, 1, 0; 0, 0, 0, 0, 0; 0, 0, 0, 0, 0; 0, 0, 0, 0, 0; 1, 0, 0, 1, 0; 0, |
| | 0, 0, 0, 0; 0, 0, 0, 0, 0; 1, 0, 0, 1, 0; 1, 0, 0, 1, 0) |

From the above the “cyclic prefix bits” are defined as modulating bits with states as follows: (BN0, BN1 . . . BN19)=(BN345, BN346, . . . , BN364). Thus the cyclic prefix bits are the same as the 20 bits immediately preceding the training sequence and are the last 20 bits of the first data portion. The “cyclic postfix bits” are defined as modulating bits with states as follows: (BN865, BN866 . . . BN884)=(BN520, BN521, . . . , BN539). Thus the cyclic prefix bits are the same as the 20 bits immediately following the training sequence and are the first 20 bits of the second data portion.

### Burst Format of SCE2 (Type 1-2)

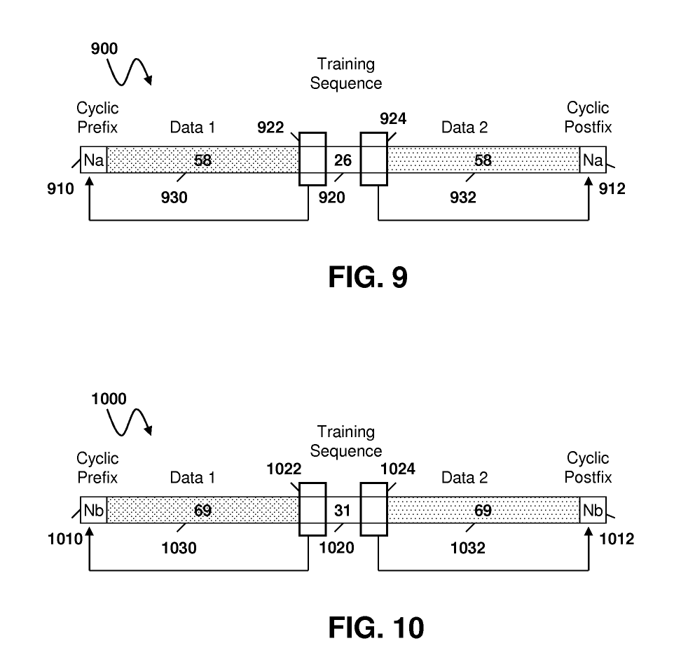

In an alternative embodiment, cyclic prefix may be obtained from a portion of the training sequence. Reference is now made to FIG. 9.

In FIG. 9, burst 900 includes a cyclic prefix 910 and a cyclic postfix 912. Cyclic prefix 910 is comprised of a portion of training sequence 920. In particular, the first number of symbols that are used in cyclic prefix 910 is provided from the beginning of training sequence 920, as shown by arrow 922.

Similarly, cyclic postfix 912 includes the end of training sequence 922, as shown by arrow 924.

Data portions 930 and 932 remain unchanged.

Similarly, for a higher symbol rate burst, reference is now made to FIG. 10. FIG. 10 shows a burst 1000, which includes a cyclic prefix 1010 and a cyclic postfix 1012. A training sequence 1020 includes a beginning portion, shown by arrow 1022, which forms cyclic prefix 1010. Similarly, training sequence 1020 includes an end portion 1024, which forms cyclic postfix 1012.

Data portions 1030 and 1032 remain unchanged.

One advantage of the embodiments of FIGS. 9 and 10 is that the training sequence is known to a receiver and the cyclic prefix/postfix will therefore be known to the receiver. This knowledge may be useful for channel tracking and estimation purposes in the receiver. The burst also provides a better backward compatibility with the legacy devices, as for a legacy device, the cyclic prefix may serve the purpose of the tail symbols.

A known cyclic prefix at the end may also be useful for blindly detecting whether or not a cyclic prefix is used for the burst. Thus, the cyclic prefix may be used to determine by a device whether the tail symbols for an EGPRS2 burst is used or whether an SCE2 burst is used by having a cyclic prefix at the end.

In accordance with FIGS. 9 and 10, an SCE2 normal burst for 16 QAM may look like Table 1 above and the training sequence code like Table 2 above. However, the “cyclic prefix bits” are defined as modulating bits with states as follows: (BN0, BN1 . . . BN11)=(BN244, BN245, . . . , BN255) and the “cyclic postfix bits” are defined as modulating bits with states as follows: (BN580, BN581 . . . BN591)=(BN336, BN337, . . . , BN347). Thus the cyclic prefix bits are the same as the 12 bits at the start of the training sequence and the cyclic postfix bits are the 12 bits at the end of the training sequence.

Similarly, an SCE2 normal burst for 32 QAM may look like Table 3 above and the training sequence code like Table 4 above. However, the “cyclic prefix bits” are defined as modulating bits with states as follows: (BN0, BN1 . . . BN14)=(BN305, BN306, . . . , BN319) and the “cyclic postfix bits” are defined as modulating bits with states as follows: (BN725, BN726 . . . BN739)=(BN420, BN421, . . . , BN434). Thus the cyclic prefix bits are the same as the 15 bits at the start of the training sequence and the cyclic postfix bits are the 15 bits at the end of the training sequence.

For a higher symbol rate burst, the SCE2 for 16 QAM is accordance with FIG. 10 may look like Table 5 above and the training sequence code like Table 6 above. However, the “cyclic prefix bits” are defined as modulating bits with states as follows: (BN0, BN1 . . . BN15)=(BN292, BN293, . . . BN307) and the “cyclic postfix bits” are defined as modulating bits with states as follows: (BN692, BN693 . . . BN707)=(BN400, BN401, . . . BN415). Thus the cyclic prefix bits are the same as the 16 bits at the start of the training sequence and the cyclic postfix bits are the same as the 16 bits at the end of the training sequence.

Similarly, the SCE2 for a higher symbol rate burst for 32 QAM may look like Table 7 above and the training sequence code like Table 8 above. However, the “cyclic prefix bits” are defined as modulating bits with states as follows: (BN0, BN1 . . . BN19)=(BN365, BN366, . . . , BN384) and where the “cyclic postfix bits” are defined as modulating bits with states as follows: (BN865, BN866 . . . BN884)=(BN500, BN501, . . . , BN519). Thus the cyclic prefix bits are the same as the 20 bits at the start of the training sequence and the cyclic postfix bits are the same as the 20 bits at the end of the training sequence.

Burst Format of SCE2 (Type 1-3)

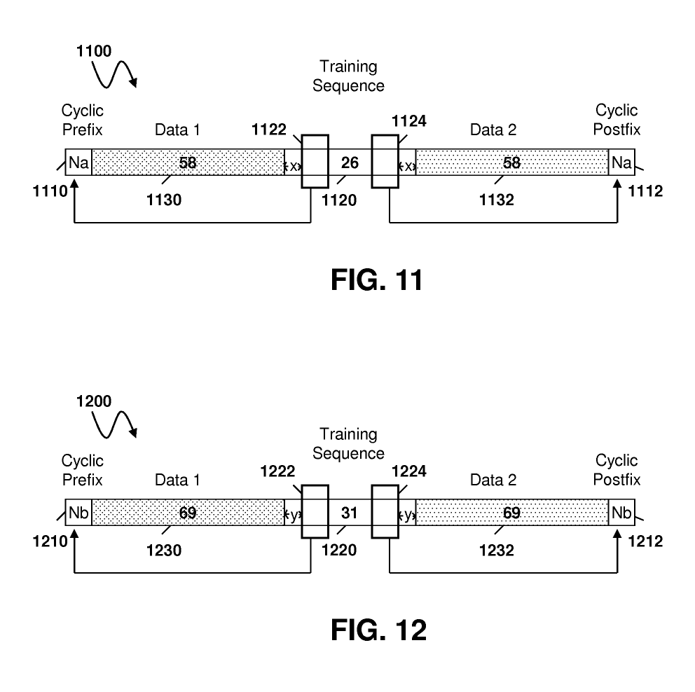

A further option is to choose the cyclic prefix parts from the training sequence symbols as shown with regard to FIGS. 11 and 12 below.

Specifically, reference is now made to FIG. 11. In FIG. 11 a burst 1100 includes a cyclic prefix 1110 and a cyclic postfix 1112. Cyclic prefix 1110 is composed of bits from training sequence 1120. Specifically, the portion of training sequence as shown by arrow 1122 forms the cyclic prefix 1110. As seen in FIG. 11, portion 1120 is offset from the beginning of the training sequence by an offset “x”.

Similarly, the portion of the training sequence 1124 forms cyclic postfix 1112. Portion 1124 is offset from the end of the training sequence by the offset “x”.

Data portions 1130 and 1132 remain unchanged.

Similarly, referring to FIG. 12, a burst 1200 forms a high bit rate burst and includes a cyclic prefix 1210 and cyclic post 1212. A portion of training sequence 1220 is used for the cyclic prefix 1210 and cyclic postfix 1212. Namely, portion 1222 is selected from the beginning of training sequence 1220 offset by “y”, and it forms cyclic prefix 1210.

Similarly, a portion 1224 from the end of training sequence 1220 offset by “y” forms cyclic postfix 1212.

The bursts shown above are all transformed at a receiver using a Discrete Fourier Transform. In the embodiments of FIGS. 11 and 12, the length of the Discrete Fourier Transform spans the burst with the offset. Since the DFT size contains the offset, the value of the offset can be chosen such that the resulting DFT size has small radix number.

For example, for the SCE2-A burst of FIG. 11, assuming that a cyclic prefix length of three symbols is used, the DFT size is 58 (for data portion 1130) plus 3 (for the training sequence symbols) plus “x”. “x” may be chosen such that DFT size of 58+x+3 yields small prime factors. Thus, if x is 3, we have a DFT size of 64, which has “2” as the smallest prime factor. The choosing of this DFT size facilitates efficient DFT implementation on a receiver.

Other prime factors that may be chosen include 3 and 5, similarly to those prime factors chosen for LTE.

For an SCE2-B burst as shown by FIG. 12, the structure is similar. Thus, the DFT size is 69+y+the cyclic prefix size. Assuming that the cyclic prefix has a length of four symbols, which is the same as the tail symbol for the EGPRS2-B tail symbol, the values shown in Table 9 below may be utilized.

TABLE 9
DFT sizes for SCE2-B

| | Prime factors of |
|---|---|
| | DFT size |
| Value of “y” | (69 + Nb + y) |
| 2 | 3, 5 |
| 7 | 2, 5 |
| 8 | 3 |
| 11 | 2, 7 |

As seen in Table 9 above, for “y” the choosing of the value of 2 yields prime factors of 3 and 5. The choosing of 7 yields prime factors of 2 and 5. The choosing of an offset of 8 yields a single prime factor of 3. The choosing of an offset of 11 yields two prime factors of 2 and 7.

Thus, from the above, one good option is to choose y=8.

The embodiment described with regard to FIGS. 11 and 12 may be presented as shown below. Specifically, for an SCE2 normal burst for 16 QAM, where a 16 QAM symbol represents 4 bits, the following may form the burst of Table 10:

TABLE 10
SCE2(Type 1-3) Normal Burst, 16 QAM

| | Length of field | |
|---|---|---|
| Bit Number (BN) | (bits) | Contents of field |
| 0-11 | 12 | cyclic prefix bits |
| 12-243 | 232 | encrypted bits (e0.e231) |
| 244-347 | 104 | training sequence bits |
| 348-579 | 232 | encrypted bits (e232.e463) |
| 580-591 | 12 | cyclic postfix bits |
| 592-624 | 33 | guard period |

From Table 10, the “training sequence bits” are defined as modulating bits with states as given in Table 11 according to the training sequence code, TSC. For BCCH and CCCH, the TSC must be equal to the BCC, as defined in 3GPP TS 23.003.

TABLE 11
Training Sequence Code

| Training | |
|---|---|
| Sequence Code | |
| (TSC) | Training sequence symbols (BN244, BN245 . . . BN347) |
| 0 | (1, 1, 1, 1; 1, 1, 1, 1; 0, 0, 1, 1; 1, 1, 1, 1; 1, 1, 1, 1; 0, 0, 1, 1; 1, 1, 1, 1; 0, 0, 1, 1; 0, 0, |
| | 1, 1; 0, 0, 1, 1; 1, 1, 1, 1; 1, 1, 1, 1; 1, 1, 1, 1; 1, 1, 1, 1; 0, 0, 1, 1; 1, 1, 1, 1; 1, 1, 1, 1; |
| | 1, 1, 1, 1; 0, 0, 1, 1; 1, 1, 1, 1; 1, 1, 1, 1; 0, 0, 1, 1; 1, 1, 1, 1; 0, 0, 1, 1; 0, 0, 1, 1; 0, 0, |
| | 1, 1) |
| 1 | (1, 1, 1, 1; 1, 1, 1, 1; 0, 0, 1, 1; 1, 1, 1, 1; 0, 0, 1, 1; 0, 0, 1, 1; 1, 1, 1, 1; 0, 0, 1, 1; 0, 0, |
| | 1, 1; 0, 0, 1, 1; 1, 1, 1, 1; 0, 0, 1, 1; 0, 0, 1, 1; 0, 0, 1, 1; 0, 0, 1, 1; 1, 1, 1, 1; 1, 1, 1, 1; |
| | 1, 1, 1, 1; 0, 0, 1, 1; 1, 1, 1, 1; 0, 0, 1, 1; 0, 0, 1, 1; 1, 1, 1, 1; 0, 0, 1, 1; 0, 0, 1, 1; 0, 0, |
| | 1, 1) |
| 2 | (1, 1, 1, 1; 0, 0, 1, 1; 1, 1, 1, 1; 1, 1, 1, 1; 1, 1, 1, 1; 1, 1, 1, 1; 0, 0, 1, 1; 0, 0, 1, 1; 0, 0, |
| | 1, 1; 1, 1, 1, 1; 0, 0, 1, 1; 0, 0, 1, 1; 0, 0, 1, 1; 1, 1, 1, 1; 0, 0, 1, 1; 1, 1, 1, 1; 1, 1, 1, 1; |
| | 0, 0, 1, 1; 1, 1, 1, 1; 1, 1, 1, 1; 1, 1, 1, 1; 1, 1, 1, 1; 0, 0, 1, 1; 0, 0, 1, 1; 0, 0, 1, 1; 1, 1, |
| | 1, 1) |
| 3 | (1, 1, 1, 1; 0, 0, 1, 1; 1, 1, 1, 1; 1, 1, 1, 1; 1, 1, 1, 1; 0, 0, 1, 1; 0, 0, 1, 1; 0, 0, 1, 1; 0, 0, |
| | 1, 1; 1, 1, 1, 1; 0, 0, 1, 1; 0, 0, 1, 1; 1, 1, 1, 1; 0, 0, 1, 1; 1, 1, 1, 1; 1, 1, 1, 1; 1, 1, 1, 1; |
| | 0, 0, 1, 1; 1, 1, 1, 1; 1, 1, 1, 1; 1, 1, 1, 1; 0, 0, 1, 1; 0, 0, 1, 1; 0, 0, 1, 1; 0, 0, 1, 1; 1, 1, |
| | 1, 1) |
| 4 | (1, 1, 1, 1; 1, 1, 1, 1; 1, 1, 1, 1; 0, 0, 1, 1; 0, 0, 1, 1; 1, 1, 1, 1; 0, 0, 1, 1; 1, 1, 1, 1; 0, 0, |
| | 1, 1; 0, 0, 1, 1; 0, 0, 1, 1; 1, 1, 1, 1; 1, 1, 1, 1; 0, 0, 1, 1; 1, 1, 1, 1; 1, 1, 1, 1; 1, 1, 1, 1; |
| | 1, 1, 1, 1; 1, 1, 1, 1; 0, 0, 1, 1; 0, 0, 1, 1; 1, 1, 1, 1; 0, 0, 1, 1; 1, 1, 1, 1; 0, 0, 1, 1; 0, 0, |
| | 1, 1) |
| 5 | (1, 1, 1, 1; 0, 0, 1, 1; 1, 1, 1, 1; 1, 1, 1, 1; 0, 0, 1, 1; 0, 0, 1, 1; 0, 0, 1, 1; 1, 1, 1, 1; 0, 0, |
| | 1, 1; 1, 1, 1, 1; 0, 0, 1, 1; 0, 0, 1, 1; 1, 1, 1, 1; 1, 1, 1, 1; 1, 1, 1, 1; 1, 1, 1, 1; 1, 1, 1, 1; |
| | 0, 0, 1, 1; 1, 1, 1, 1; 1, 1, 1, 1; 0, 0, 1, 1; 0, 0, 1, 1; 0, 0, 1, 1; 1, 1, 1, 1; 0, 0, 1, 1; 1, 1, |
| | 1, 1) |
| 6 | (0, 0, 1, 1; 1, 1, 1, 1; 0, 0, 1, 1; 1, 1, 1, 1; 1, 1, 1, 1; 0, 0, 1, 1; 0, 0, 1, 1; 0, 0, 1, 1; 0, 0, |
| | 1, 1; 0, 0, 1, 1; 1, 1, 1, 1; 0, 0, 1, 1; 0, 0, 1, 1; 1, 1, 1, 1; 1, 1, 1, 1; 1, 1, 1, 1; 0, 0, 1, 1; |
| | 1, 1, 1, 1; 0, 0, 1, 1; 1, 1, 1, 1; 1, 1, 1, 1; 0, 0, 1, 1; 0, 0, 1, 1; 0, 0, 1, 1; 0, 0, 1, 1; 0, 0, |
| | 1, 1) |
| 7 | (0, 0, 1, 1; 0, 0, 1, 1; 0, 0, 1, 1; 1, 1, 1, 1; 0, 0, 1, 1; 0, 0, 1, 1; 0, 0, 1, 1; 0, 0, 1, 1; 1, 1, |
| | 1, 1; 1, 1, 1, 1; 1, 1, 1, 1; 0, 0, 1, 1; 1, 1, 1, 1; 1, 1, 1, 1; 0, 0, 1, 1; 1, 1, 1, 1; 0, 0, 1, 1; |
| | 0, 0, 1, 1; 0, 0, 1, 1; 1, 1, 1, 1; 0, 0, 1, 1; 0, 0, 1, 1; 0, 0, 1, 1; 0, 0, 1, 1; 1, 1, 1, 1; 1, 1, |
| | 1, 1) |

From the above, the “cyclic prefix bits” are defined as modulating bits with states as follows: (BN0, BN1 . . . BN11)=(BN256, BN257, . . . , BN267) and the “cyclic postfix bits” are defined as modulating bits with states as follows: (BN580, BN581 . . . BN591)=(BN324, BN325, . . . , BN335). Thus the cyclic prefix bits are same as the twelve bits offset from the start of the training sequence by 12 bits and the cyclic postfix bits are the same as the 12 bits offset from the end of the training sequence by 12 bits.

Similarly, for an SCE2 normal burst with 32 QAM, where a 32 QAM symbol represents 5 bits, the burst may be as follows in Table 12:

TABLE 12
SCE2(Type 1-3) Normal Burst, 32 QAM

| | Length of field | |
|---|---|---|
| Bit Number (BN) | (bits) | Contents of field |
| 0-14 | 15 | cyclic prefix bits |
| 15-304 | 290 | encrypted bits (e0.e289) |
| 305-434 | 130 | training sequence bits |
| 435-724 | 290 | encrypted bits (e290.e579) |
| 725-739 | 15 | cyclic postfix bits |
| 740-781 | 41.25 | guard period |

In Table 12 the “training sequence bits” are defined as modulating bits with states as given in Table 13 according to the training sequence code, TSC. For BCCH and CCCH, the TSC must be equal to the BCC, as defined in 3GPP TS 23.003. In networks supporting E-OTD Location services (see 3GPP TS 43.059), the use of 32 QAM modulation on BCCH frequencies might degrade E-OTD Location service performance.

TABLE 13
Training Sequence Code

| Training | |
|---|---|
| Sequence Code | |
| (TSC) | Training sequence symbols (BN305, BN306 . . . BN434) |
| 0 | (0, 0, 0, 0, 0; 0, 0, 0, 0, 0; 1, 0, 0, 1, 0; 0, 0, 0, 0, 0; 0, 0, 0, 0, 0; 1, 0, 0, 1, 0; 0, 0, 0, 0, |
| | 0; 1, 0, 0, 1, 0; 1, 0, 0, 1, 0; 1, 0, 0, 1, 0; 0, 0, 0, 0, 0; 0, 0, 0, 0, 0; 0, 0, 0, 0, 0; 0, 0, 0, |
| | 0, 0; 1, 0, 0, 1, 0; 0, 0, 0, 0, 0; 0, 0, 0, 0, 0; 0, 0, 0, 0, 0; 1, 0, 0, 1, 0; 0, 0, 0, 0, 0; 0, 0, |
| | 0, 0, 0; 1, 0, 0, 1, 0; 0, 0, 0, 0, 0; 1, 0, 0, 1, 0; 1, 0, 0, 1, 0; 1, 0, 0, 1, 0) |
| 1 | (0, 0, 0, 0, 0; 0, 0, 0, 0, 0; 1, 0, 0, 1, 0; 0, 0, 0, 0, 0; 1, 0, 0, 1, 0; 1, 0, 0, 1, 0; 0, 0, 0, 0, |
| | 0; 1, 0, 0, 1, 0; 1, 0, 0, 1, 0; 1, 0, 0, 1, 0; 0, 0, 0, 0, 0; 1, 0, 0, 1, 0; 1, 0, 0, 1, 0; 1, 0, 0, |
| | 1, 0; 1, 0, 0, 1, 0; 0, 0, 0, 0, 0; 0, 0, 0, 0, 0; 0, 0, 0, 0, 0; 1, 0, 0, 1, 0; 0, 0, 0, 0, 0; 1, 0, |
| | 0, 1, 0; 1, 0, 0, 1, 0; 0, 0, 0, 0, 0; 1, 0, 0, 1, 0; 1, 0, 0, 1, 0; 1, 0, 0, 1, 0) |
| 2 | (0, 0, 0, 0, 0; 1, 0, 0, 1, 0; 0, 0, 0, 0, 0; 0, 0, 0, 0, 0; 0, 0, 0, 0, 0; 0, 0, 0, 0, 0; 1, 0, 0, 1, |
| | 0; 1, 0, 0, 1, 0; 1, 0, 0, 1, 0; 0, 0, 0, 0, 0; 1, 0, 0, 1, 0; 1, 0, 0, 1, 0; 1, 0, 0, 1, 0; 0, 0, 0, |
| | 0, 0; 1, 0, 0, 1, 0; 0, 0, 0, 0, 0; 0, 0, 0, 0, 0; 1, 0, 0, 1, 0; 0, 0, 0, 0, 0; 0, 0, 0, 0, 0; 0, 0, |
| | 0, 0, 0; 0, 0, 0, 0, 0; 1, 0, 0, 1, 0; 1, 0, 0, 1, 0; 1, 0, 0, 1, 0; 0, 0, 0, 0, 0) |
| 3 | (0, 0, 0, 0, 0; 1, 0, 0, 1, 0; 0, 0, 0, 0, 0; 0, 0, 0, 0, 0; 0, 0, 0, 0, 0; 1, 0, 0, 1, 0; 1, 0, 0, 1, |
| | 0; 1, 0, 0, 1, 0; 1, 0, 0, 1, 0; 0, 0, 0, 0, 0; 1, 0, 0, 1, 0; 1, 0, 0, 1, 0; 0, 0, 0, 0, 0; 1, 0, 0, |
| | 1, 0; 0, 0, 0, 0, 0; 0, 0, 0, 0, 0; 0, 0, 0, 0, 0; 1, 0, 0, 1, 0; 0, 0, 0, 0, 0; 0, 0, 0, 0, 0; 0, 0, |
| | 0, 0, 0; 1, 0, 0, 1, 0; 1, 0, 0, 1, 0; 1, 0, 0, 1, 0; 1, 0, 0, 1, 0; 0, 0, 0, 0, 0) |
| 4 | (0, 0, 0, 0, 0; 0, 0, 0, 0, 0; 0, 0, 0, 0, 0; 1, 0, 0, 1, 0; 1, 0, 0, 1, 0; 0, 0, 0, 0, 0; 1, 0, 0, 1, |
| | 0; 0, 0, 0, 0, 0; 1, 0, 0, 1, 0; 1, 0, 0, 1, 0; 1, 0, 0, 1, 0; 0, 0, 0, 0, 0; 0, 0, 0, 0, 0; 1, 0, 0, |
| | 1, 0; 0, 0, 0, 0, 0; 0, 0, 0, 0, 0; 0, 0, 0, 0, 0; 0, 0, 0, 0, 0; 0, 0, 0, 0, 0; 1, 0, 0, 1, 0; 1, 0, |
| | 0, 1, 0; 0, 0, 0, 0, 0; 1, 0, 0, 1, 0; 0, 0, 0, 0, 0; 1, 0, 0, 1, 0; 1, 0, 0, 1, 0) |
| 5 | (0, 0, 0, 0, 0; 1, 0, 0, 1, 0; 0, 0, 0, 0, 0; 0, 0, 0, 0, 0; 1, 0, 0, 1, 0; 1, 0, 0, 1, 0; 1, 0, 0, 1, |
| | 0; 0, 0, 0, 0, 0; 1, 0, 0, 1, 0; 0, 0, 0, 0, 0; 1, 0, 0, 1, 0; 1, 0, 0, 1, 0; 0, 0, 0, 0, 0; 0, 0, 0, |
| | 0, 0; 0, 0, 0, 0, 0; 0, 0, 0, 0, 0; 0, 0, 0, 0, 0; 1, 0, 0, 1, 0; 0, 0, 0, 0, 0; 0, 0, 0, 0, 0; 1, 0, |
| | 0, 1, 0; 1, 0, 0, 1, 0; 1, 0, 0, 1, 0; 0, 0, 0, 0, 0; 1, 0, 0, 1, 0; 0, 0, 0, 0, 0) |
| 6 | (1, 0, 0, 1, 0; 0, 0, 0, 0, 0; 1, 0, 0, 1, 0; 0, 0, 0, 0, 0; 0, 0, 0, 0, 0; 1, 0, 0, 1, 0; 1, 0, 0, 1, |
| | 0; 1, 0, 0, 1, 0; 1, 0, 0, 1, 0; 1, 0, 0, 1, 0; 0, 0, 0, 0, 0; 1, 0, 0, 1, 0; 1, 0, 0, 1, 0; 0, 0, 0, |
| | 0, 0; 0, 0, 0, 0, 0; 0, 0, 0, 0, 0; 1, 0, 0, 1, 0; 0, 0, 0, 0, 0; 1, 0, 0, 1, 0; 0, 0, 0, 0, 0; 0, 0, |
| | 0, 0, 0; 1, 0, 0, 1, 0; 1, 0, 0, 1, 0; 1, 0, 0, 1, 0; 1, 0, 0, 1, 0; 1, 0, 0, 1, 0) |
| 7 | (1, 0, 0, 1, 0; 1, 0, 0, 1, 0; 1, 0, 0, 1, 0; 0, 0, 0, 0, 0; 1, 0, 0, 1, 0; 1, 0, 0, 1, 0; 1, 0, 0, 1, |
| | 0; 1, 0, 0, 1, 0; 0, 0, 0, 0, 0; 0, 0, 0, 0, 0; 0, 0, 0, 0, 0; 1, 0, 0, 1, 0; 0, 0, 0, 0, 0; 0, 0, 0, |
| | 0, 0; 1, 0, 0, 1, 0; 0, 0, 0, 0, 0; 1, 0, 0, 1, 0; 1, 0, 0, 1, 0; 1, 0, 0, 1, 0; 0, 0, 0, 0, 0; 1, 0, |
| | 0, 1, 0; 1, 0, 0, 1, 0; 1, 0, 0, 1, 0; 1, 0, 0, 1, 0; 0, 0, 0, 0, 0; 0, 0, 0, 0, 0) |

From the above, the “cyclic prefix bits” are defined as modulating bits with states as follows: (BN0, BN1 . . . BN14)=(BN320, BN321, . . . , BN334) and the “cyclic postfix bits” are defined as modulating bits with states as follows: (BN725, BN726 . . . BN739)=(BN401, BN402, . . . , BN419). Thus the cyclic prefix bits are the same as the 15 bits offset from the start of the training sequence by 15 bits and the cyclic postfix bits are the same as the 15 bits offset from the end of the training sequence by 15 bits.

For a high data rate SCE2 16 QAM burst, where a 16 QAM symbol represents 4 bits, the burst may be that shown in Table 14:

TABLE 14
SCE2(Type 1-3) High Symbol Rate Burst, 16 QAM

| | Length of field | |
|---|---|---|
| Bit Number (BN) | (bits) | Contents of field |
| 0-15 | 16 | cyclic prefix bits |
| 16-291 | 276 | encrypted bits (e0.e275) |
| 292-415 | 124 | training sequence bits |
| 416-691 | 276 | encrypted bits (e276.e551) |
| 692-707 | 16 | cyclic postfix bits |
| 708-749 | 42 | guard period |

From Table 14, the “training sequence bits” are defined as modulating bits with states as given in Table 15 according to the training sequence code, TSC. For BCCH and CCCH, the TSC must be equal to the BCC, as defined in 3GPP TS 23.003.

TABLE 15
Training Sequence Code

| Training | |
|---|---|
| Sequence Code | |
| (TSC) | Training sequence symbols (BN292, BN293 . . . BN415) |
| 0 | (0, 0, 1, 1; 1, 1, 1, 1; 0, 0, 1, 1; 0, 0, 1, 1; 1, 1, 1, 1; 0, 0, 1, 1; 0, 0, 1, 1; 0, 0, 1, 1; 1, 1, |
| | 1, 1; 0, 0, 1, 1; 1, 1, 1, 1; 1, 1, 1, 1; 1, 1, 1, 1; 1, 1, 1, 1; 1, 1, 1, 1; 1, 1, 1, 1; 1, 1, 1, 1; |
| | 0, 0, 1, 1; 0, 0, 1, 1; 1, 1, 1, 1; 0, 0, 1, 1; 1, 1, 1, 1; 1, 1, 1, 1; 1, 1, 1, 1; 1, 1, 1, 1; 0, 0, |
| | 1, 1; 0, 0, 1, 1; 1, 1, 1, 1; 1, 1, 1, 1; 1, 1, 1, 1; 0, 0, 1, 1) |
| 1 | (1, 1, 1, 1; 1, 1, 1, 1; 1, 1, 1, 1; 0, 0, 1, 1; 0, 0, 1, 1; 1, 1, 1, 1; 1, 1, 1, 1; 0, 0, 1, 1; 0, 0, |
| | 1, 1; 0, 0, 1, 1; 1, 1, 1, 1; 1, 1, 1, 1; 1, 1, 1, 1; 1, 1, 1, 1; 1, 1, 1, 1; 0, 0, 1, 1; 1, 1, 1, 1; |
| | 0, 0, 1, 1; 1, 1, 1, 1; 1, 1, 1, 1; 0, 0, 1, 1; 1, 1, 1, 1; 0, 0, 1, 1; 0, 0, 1, 1; 0, 0, 1, 1; 1, 1, |
| | 1, 1; 0, 0, 1, 1; 0, 0, 1, 1; 1, 1, 1, 1; 0, 0, 1, 1; 0, 0, 1, 1) |
| 2 | (1, 1, 1, 1; 0, 0, 1, 1; 0, 0, 1, 1; 1, 1, 1, 1; 1, 1, 1, 1; 1, 1, 1, 1; 0, 0, 1, 1; 1, 1, 1, 1; 1, 1, |
| | 1, 1; 1, 1, 1, 1; 0, 0, 1, 1; 0, 0, 1, 1; 1, 1, 1, 1; 0, 0, 1, 1; 1, 1, 1, 1; 1, 1, 1, 1; 0, 0, 1, 1; |
| | 1, 1, 1, 1; 1, 1, 1, 1; 1, 1, 1, 1; 1, 1, 1, 1; 1, 1, 1, 1; 0, 0, 1, 1; 0, 0, 1, 1; 0, 0, 1, 1; 1, 1, |
| | 1, 1; 0, 0, 1, 1; 1, 1, 1, 1; 0, 0, 1, 1; 0, 0, 1, 1; 0, 0, 1, 1) |
| 3 | (0, 0, 1, 1; 0, 0, 1, 1; 0, 0, 1, 1; 0, 0, 1, 1; 1, 1, 1, 1; 1, 1, 1, 1; 1, 1, 1, 1; 0, 0, 1, 1; 0, 0, |
| | 1, 1; 0, 0, 1, 1; 0, 0, 1, 1; 0, 0, 1, 1; 0, 0, 1, 1; 1, 1, 1, 1; 0, 0, 1, 1; 0, 0, 1, 1; 1, 1, 1, 1; |
| | 1, 1, 1, 1; 1, 1, 1, 1; 0, 0, 1, 1; 1, 1, 1, 1; 0, 0, 1, 1; 1, 1, 1, 1; 1, 1, 1, 1; 0, 0, 1, 1; 0, 0, |
| | 1, 1; 1, 1, 1, 1; 0, 0, 1, 1; 1, 1, 1, 1; 0, 0, 1, 1; 0, 0, 1, 1) |
| 4 | (1, 1, 1, 1; 0, 0, 1, 1; 1, 1, 1, 1; 0, 0, 1, 1; 0, 0, 1, 1; 1, 1, 1, 1; 1, 1, 1, 1; 1, 1, 1, 1; 0, 0, |
| | 1, 1; 0, 0, 1, 1; 0, 0, 1, 1; 1, 1, 1, 1; 1, 1, 1, 1; 0, 0, 1, 1; 1, 1, 1, 1; 1, 1, 1, 1; 0, 0, 1, 1; |
| | 0, 0, 1, 1; 1, 1, 1, 1; 0, 0, 1, 1; 1, 1, 1, 1; 1, 1, 1, 1; 1, 1, 1, 1; 1, 1, 1, 1; 1, 1, 1, 1; 1, 1, |
| | 1, 1; 1, 1, 1, 1; 0, 0, 1, 1; 1, 1, 1, 1; 0, 0, 1, 1; 0, 0, 1, 1) |
| 5 | (0, 0, 1, 1; 0, 0, 1, 1; 1, 1, 1, 1; 0, 0, 1, 1; 1, 1, 1, 1; 0, 0, 1, 1; 0, 0, 1, 1; 1, 1, 1, 1; 1, 1, |
| | 1, 1; 0, 0, 1, 1; 1, 1, 1, 1; 0, 0, 1, 1; 1, 1, 1, 1; 1, 1, 1, 1; 1, 1, 1, 1; 0, 0, 1, 1; 0, 0, 1, 1; |
| | 1, 1, 1, 1; 0, 0, 1, 1; 0, 0, 1, 1; 0, 0, 1, 1; 0, 0, 1, 1; 0, 0, 1, 1; 0, 0, 1, 1; 1, 1, 1, 1; 1, 1, |
| | 1, 1; 1, 1, 1, 1; 0, 0, 1, 1; 0, 0, 1, 1; 0, 0, 1, 1; 0, 0, 1, 1) |
| 6 | (1, 1, 1, 1; 0, 0, 1, 1; 1, 1, 1, 1; 1, 1, 1, 1; 1, 1, 1, 1; 1, 1, 1, 1; 1, 1, 1, 1; 1, 1, 1, 1; 0, 0, |
| | 1, 1; 1, 1, 1, 1; 1, 1, 1, 1; 0, 0, 1, 1; 1, 1, 1, 1; 0, 0, 1, 1; 0, 0, 1, 1; 0, 0, 1, 1; 1, 1, 1, 1; |
| | 1, 1, 1, 1; 1, 1, 1, 1; 0, 0, 1, 1; 1, 1, 1, 1; 1, 1, 1, 1; 0, 0, 1, 1; 0, 0, 1, 1; 0, 0, 1, 1; 1, 1, |
| | 1, 1; 1, 1, 1, 1; 1, 1, 1, 1; 0, 0, 1, 1; 1, 1, 1, 1; 0, 0, 1, 1) |
| 7 | (1, 1, 1, 1; 0, 0, 1, 1; 1, 1, 1, 1; 1, 1, 1, 1; 1, 1, 1, 1; 1, 1, 1, 1; 1, 1, 1, 1; 0, 0, 1, 1; 1, 1, |
| | 1, 1; 1, 1, 1, 1; 0, 0, 1, 1; 1, 1, 1, 1; 0, 0, 1, 1; 1, 1, 1, 1; 1, 1, 1, 1; 1, 1, 1, 1; 0, 0, 1, 1; |
| | 0, 0, 1, 1; 0, 0, 1, 1; 0, 0, 1, 1; 1, 1, 1, 1; 1, 1, 1, 1; 0, 0, 1, 1; 1, 1, 1, 1; 1, 1, 1, 1; 1, 1, |
| | 1, 1; 0, 0, 1, 1; 1, 1, 1, 1; 1, 1, 1, 1; 0, 0, 1, 1; 0, 0, 1, 1) |

From the above, the “cyclic prefix bits” are defined as modulating bits with states as follows: (BN0, BN1 . . . BN15)=(BN324, BN325, . . . BN339) and the “cyclic postfix bits” are defined as modulating bits with states as follows: (BN692, BN693 . . . BN707)=(BN368, BN369, . . . BN383). Thus the cyclic prefix bits are the same as the 16 bits offset from the start of the training sequence by 32 bits and the cyclic postfix bits are the same as the 16 bits offset from the end of the training sequence by 32 bits.

Similarly, an SCE2 high symbol rate 32 QAM burst, where a 32 QAM symbol represents 5 bits, may be shown in Table 16:

TABLE 16
SCE2(Type 1-3) High Symbol Rate Burst, 32 QAM

| | Length of field | |
|---|---|---|
| Bit Number (BN) | (bits) | Contents of field |
| 0-19 | 20 | cyclic prefix bits |
| 20-364 | 345 | Encrypted bits (e0.e344) |
| 365-519 | 155 | training sequence bits |
| 520-864 | 345 | encrypted bits (e345.e689) |
| 865-884 | 20 | cyclic postf ix bits |
| 885-937 | 52.5 | guard period |

From Table 16, the “training sequence bits” are defined as modulating bits with states as given in Table 17 according to the training sequence code, TSC. For BCCH and CCCH, the TSC must be equal to the BCC, as defined in 3GPP TS 23.003.

TABLE 17
Training Sequence Code

| Training | |
|---|---|
| Sequence Code | |
| (TSC) | Training sequence symbols (BN365, BN366 . . . BN519) |
| 0 | (1, 0, 0, 1, 0; 0, 0, 0, 0, 0; 1, 0, 0, 1, 0; 1, 0, 0, 1, 0; 0, 0, 0, 0, 0; 1, 0, 0, 1, 0; 1, 0, 0, 1, |
| | 0; 1, 0, 0, 1, 0; 0, 0, 0, 0, 0; 1, 0, 0, 1, 0; 0, 0, 0, 0, 0; 0, 0, 0, 0, 0; 0, 0, 0, 0, 0; 0, 0, 0, |
| | 0, 0; 0, 0, 0, 0, 0; 0, 0, 0, 0, 0; 0, 0, 0, 0, 0; 1, 0, 0, 1, 0; 1, 0, 0, 1, 0; 0, 0, 0, 0, 0; 1, 0, |
| | 0, 1, 0; 0, 0, 0, 0, 0; 0, 0, 0, 0, 0; 0, 0, 0, 0, 0; 0, 0, 0, 0, 0; 1, 0, 0, 1, 0; 1, 0, 0, 1, 0; 0, |
| | 0, 0, 0, 0; 0, 0, 0, 0, 0; 0, 0, 0, 0, 0; 1, 0, 0, 1, 0) |
| 1 | (0, 0, 0, 0, 0; 0, 0, 0, 0, 0; 0, 0, 0, 0, 0; 1, 0, 0, 1, 0; 1, 0, 0, 1, 0; 0, 0, 0, 0, 0; 0, 0, 0, 0, |
| | 0; 1, 0, 0, 1, 0; 1, 0, 0, 1, 0; 1, 0, 0, 1, 0; 0, 0, 0, 0, 0; 0, 0, 0, 0, 0; 0, 0, 0, 0, 0; 0, 0, 0, |
| | 0, 0; 0, 0, 0, 0, 0; 1, 0, 0, 1, 0; 0, 0, 0, 0, 0; 1, 0, 0, 1, 0; 0, 0, 0, 0, 0; 0, 0, 0, 0, 0; 1, 0, |
| | 0, 1, 0; 0, 0, 0, 0, 0; 1, 0, 0, 1, 0; 1, 0, 0, 1, 0; 1, 0, 0, 1, 0; 0, 0, 0, 0, 0; 1, 0, 0, 1, 0; 1, |
| | 0, 0, 1, 0; 0, 0, 0, 0, 0; 1, 0, 0, 1, 0; 1, 0, 0, 1, 0) |
| 2 | (0, 0, 0, 0, 0; 1, 0, 0, 1, 0; 1, 0, 0, 1, 0; 0, 0, 0, 0, 0; 0, 0, 0, 0, 0; 0, 0, 0, 0, 0; 1, 0, 0, 1, |
| | 0; 0, 0, 0, 0, 0; 0, 0, 0, 0, 0; 0, 0, 0, 0, 0; 1, 0, 0, 1, 0; 1, 0, 0, 1, 0; 0, 0, 0, 0, 0; 1, 0, 0, |
| | 1, 0; 0, 0, 0, 0, 0; 0, 0, 0, 0, 0; 1, 0, 0, 1, 0; 0, 0, 0, 0, 0; 0, 0, 0, 0, 0; 0, 0, 0, 0, 0; 0, 0, |
| | 0, 0, 0; 0, 0, 0, 0, 0; 1, 0, 0, 1, 0; 1, 0, 0, 1, 0; 1, 0, 0, 1, 0; 0, 0, 0, 0, 0; 1, 0, 0, 1, 0; 0, |
| | 0, 0, 0, 0; 1, 0, 0, 1, 0; 1, 0, 0, 1, 0; 1, 0, 0, 1, 0) |
| 3 | (1, 0, 0, 1, 0; 1, 0, 0, 1, 0; 1, 0, 0, 1, 0; 1, 0, 0, 1, 0; 0, 0, 0, 0, 0; 0, 0, 0, 0, 0; 0, 0, 0, 0, |
| | 0; 1, 0, 0, 1, 0; 1, 0, 0, 1, 0; 1, 0, 0, 1, 0; 1, 0, 0, 1, 0; 1, 0, 0, 1, 0; 1, 0, 0, 1, 0; 0, 0, 0, |
| | 0, 0; 1, 0, 0, 1, 0; 1, 0, 0, 1, 0; 0, 0, 0, 0, 0; 0, 0, 0, 0, 0; 0, 0, 0, 0, 0; 1, 0, 0, 1, 0; 0, 0, |
| | 0, 0, 0; 1, 0, 0, 1, 0; 0, 0, 0, 0, 0; 0, 0, 0, 0, 0; 1, 0, 0, 1, 0; 1, 0, 0, 1, 0; 0, 0, 0, 0, 0; 1, |
| | 0, 0, 1, 0; 0, 0, 0, 0, 0; 1, 0, 0, 1, 0; 1, 0, 0, 1, 0) |
| 4 | (0, 0, 0, 0, 0; 1, 0, 0, 1, 0; 0, 0, 0, 0, 0; 1, 0, 0, 1, 0; 1, 0, 0, 1, 0; 0, 0, 0, 0, 0; 0, 0, 0, 0, |
| | 0; 0, 0, 0, 0, 0; 1, 0, 0, 1, 0; 1, 0, 0, 1, 0; 1, 0, 0, 1, 0; 0, 0, 0, 0, 0; 0, 0, 0, 0, 0; 1, 0, 0, |
| | 1, 0; 0, 0, 0, 0, 0; 0, 0, 0, 0, 0; 1, 0, 0, 1, 0; 1, 0, 0, 1, 0; 0, 0, 0, 0, 0; 1, 0, 0, 1, 0; 0, 0, |
| | 0, 0, 0; 0, 0, 0, 0, 0; 0, 0, 0, 0, 0; 0, 0, 0, 0, 0; 0, 0, 0, 0, 0; 0, 0, 0, 0, 0; 0, 0, 0, 0, 0; 1, |
| | 0, 0, 1, 0; 0, 0, 0, 0, 0; 1, 0, 0, 1, 0; 1, 0, 0, 1, 0) |
| 5 | (1, 0, 0, 1, 0; 1, 0, 0, 1, 0; 0, 0, 0, 0, 0; 1, 0, 0, 1, 0; 0, 0, 0, 0, 0; 1, 0, 0, 1, 0; 1, 0, 0, 1, |
| | 0; 0, 0, 0, 0, 0; 0, 0, 0, 0, 0; 1, 0, 0, 1, 0; 0, 0, 0, 0, 0; 1, 0, 0, 1, 0; 0, 0, 0, 0, 0; 0, 0, 0, |
| | 0, 0; 0, 0, 0, 0, 0; 1, 0, 0, 1, 0; 1, 0, 0, 1, 0; 0, 0, 0, 0, 0; 1, 0, 0, 1, 0; 1, 0, 0, 1, 0; 1, 0, |
| | 0, 1, 0; 1, 0, 0, 1, 0; 1, 0, 0, 1, 0; 1, 0, 0, 1, 0; 0, 0, 0, 0, 0; 0, 0, 0, 0, 0; 0, 0, 0, 0, 0; 1, |
| | 0, 0, 1, 0; 1, 0, 0, 1, 0; 1, 0, 0, 1, 0; 1, 0, 0, 1, 0) |
| 6 | (0, 0, 0, 0, 0; 1, 0, 0, 1, 0; 0, 0, 0, 0, 0; 0, 0, 0, 0, 0; 0, 0, 0, 0, 0; 0, 0, 0, 0, 0; 0, 0, 0, 0, |
| | 0; 0, 0, 0, 0, 0; 1, 0, 0, 1, 0; 0, 0, 0, 0, 0; 0, 0, 0, 0, 0; 1, 0, 0, 1, 0; 0, 0, 0, 0, 0; 1, 0, 0, |
| | 1, 0; 1, 0, 0, 1, 0; 1, 0, 0, 1, 0; 0, 0, 0, 0, 0; 0, 0, 0, 0, 0; 0, 0, 0, 0, 0; 1, 0, 0, 1, 0; 0, 0, |
| | 0, 0, 0; 0, 0, 0, 0, 0; 1, 0, 0, 1, 0; 1, 0, 0, 1, 0; 1, 0, 0, 1, 0; 0, 0, 0, 0, 0; 0, 0, 0, 0, 0; 0, |
| | 0, 0, 0, 0; 1, 0, 0, 1, 0; 0, 0, 0, 0, 0; 1, 0, 0, 1, 0) |
| 7 | (0, 0, 0, 0, 0; 1, 0, 0, 1, 0; 0, 0, 0, 0, 0; 0, 0, 0, 0, 0; 0, 0, 0, 0, 0; 0, 0, 0, 0, 0; 0, 0, 0, 0, |
| | 0; 1, 0, 0, 1, 0; 0, 0, 0, 0, 0; 0, 0, 0, 0, 0; 1, 0, 0, 1, 0; 0, 0, 0, 0, 0; 1, 0, 0, 1, 0; 0, 0, 0, |
| | 0, 0; 0, 0, 0, 0, 0; 0, 0, 0, 0, 0; 1, 0, 0, 1, 0; 1, 0, 0, 1, 0; 1, 0, 0, 1, 0; 1, 0, 0, 1, 0; 0, 0, |
| | 0, 0, 0; 0, 0, 0, 0, 0; 1, 0, 0, 1, 0; 0, 0, 0, 0, 0; 0, 0, 0, 0, 0; 0, 0, 0, 0, 0; 1, 0, 0, 1, 0; 0, |
| | 0, 0, 0, 0; 0, 0, 0, 0, 0; 1, 0, 0, 1, 0; 1, 0, 0, 1, 0) |

From the above, the “cyclic prefix bits” are defined as modulating bits with states as follows: (BN0, BN1 . . . BN19)=(BN405, BN406, . . . , BN424) and the “cyclic postfix bits” are defined as modulating bits with states as follows: (BN865, BN866 . . . BN884)=(BN460, BN461, . . . , BN479). Thus the cyclic prefix bits are the same as the 20 bits offset from the start of the training sequence by 40 bits and the cyclic postfix bits are the same as the 20 bits offset from the end of the training sequence by 40 bits.

Burst Format of SCE2 (Type 2-1)

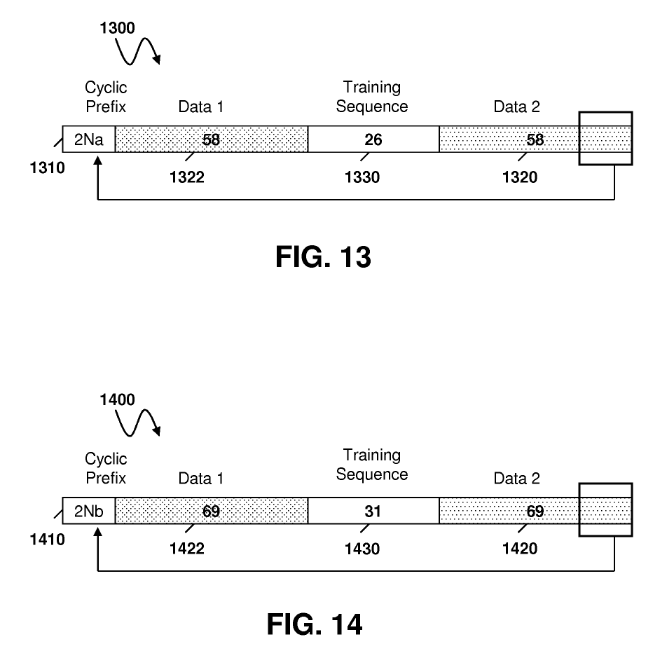

In a further alternative, a burst as shown by FIGS. 13 and 14 may be provided.

FIG. 13 shows an SCE2 (Type 2-1) burst 1300 that combines both cyclic prefixes at the start of the burst. The burst otherwise retains the exact ordering of both the data and training sequence.

Thus, a cyclic prefix 1310 includes the end of symbols from data portion 1320. Data portion 1322 remains unchanged, as does training sequence 1330.

Similarly, for a higher symbol rate burst, reference is now made to FIG. 14. FIG. 14 shows burst 1400, which includes a cyclic prefix 1410 comprised of bits taken from the end of data portion 1420.

Data portion 1422 and training sequence 1430 remain unchanged.

When compared to Type 1-1 burst structures, the bursts 1300 and 1400 shift both cyclic prefix and postfix to the beginning of the burst. This allows for a cyclic prefix that this twice as long as that of the burst structures of Type 1 without any additional puncturing on data and this could be useful in some cases for channels with longer delay spread.

However, the training sequences 1330 and 1430 of bursts 1300 and 1400 respectively are not in the middle of the burst. This may have some impact on the legacy implementations. The impact may be minimal since legacy mobiles typically perform timing synchronization on a burst by burst basis except in a dual transfer mode where the circuit switched and packet switched slots might look staggered since the circuit switched burst utilizes the legacy formatting whereas the packet switched burst utilizes burst formats 1300 and 1400.

Burst Format of SCE2-(Type 2-2)

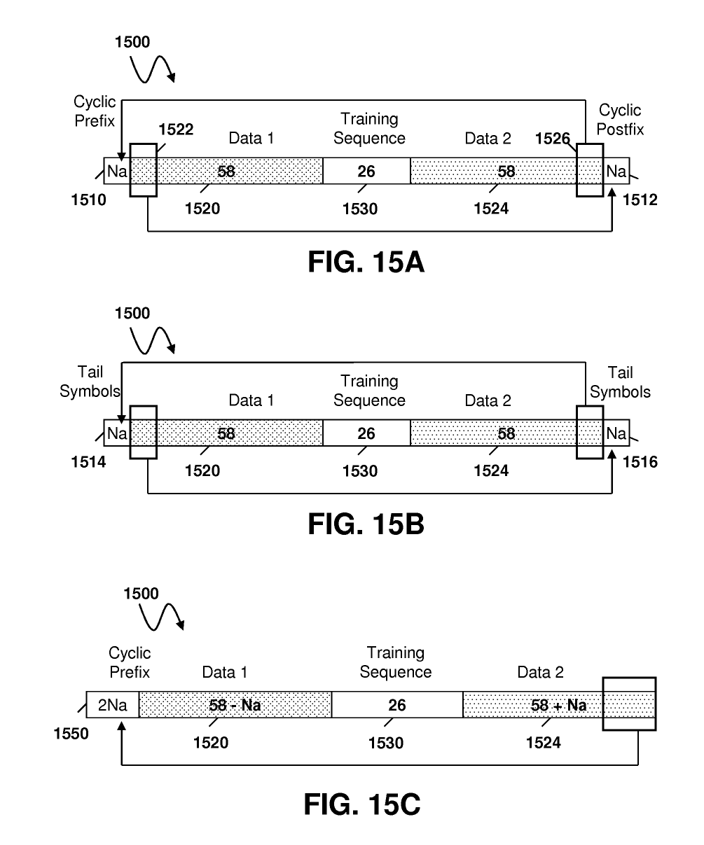

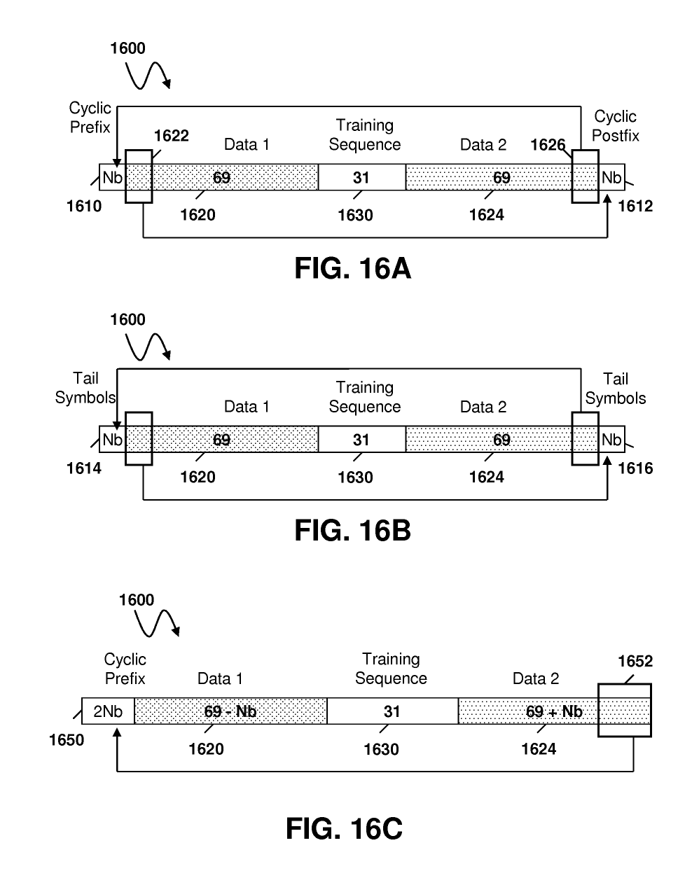

To enable placement of training sequence in the middle of a burst whilst still retaining the effective cyclic prefix length as long as the one shown in burst formats of Type 2-1, an alternative is shown with regard to FIG. 15A. Similarly, a high symbol rate equivalent is shown with regards to FIG. 16A.

The embodiment of FIG. 15A shows a burst 1500 at a transmitter. In the embodiment of FIG. 15A, the burst includes a cyclic prefix 1510 and cyclic postfix 1512. The cyclic postfix 1512 is comprised of a first part of data portion 1520, as shown by arrow 1522.

Similarly, end of data portion 1524, shown by arrow 1526, forms cyclic prefix 1510.

Training sequence 1530 remains unchanged.

The burst is seen differently by a legacy receiver than from an SCE2 mobile device receiver. From a legacy mobile device perspective, the only change in the burst structure is to the tail symbols. Thus, referring to FIG. 15B, a legacy mobile device will see a burst 1500 with essentially tail symbols (which may be different to the legacy tail symbols) 1514 and 1516 as well as data portions 1520 and 1524 and a training sequence 1530.

Conversely, an SCE2 mobile device may view the burst format as being equivalent to having a single cyclic prefix with double the length. Referring to FIG. 15C, the burst format 1500 as seen from an SCE2 mobile device receiver includes a cyclic prefix 1550 with the data portion 1520, with length of 58−Na, data portion 1524, with length of 58+Na, and training sequence portion 1530.

Similarly, for a higher symbol rate burst, reference is made to FIG. 16. FIG. 16A shows the burst format at a transmitter and in particular shows bursts 1600 which is comprised of a cyclic prefix 1620 and a cyclic postfix 1612. A portion of first data portion 1620, as shown by arrow 1622 is used for cyclic postfix 1612.

Similarly, the end portion of data portion 1624 as, shown by arrow 1626, is used for cyclic prefix 1610.

Training sequence 1630 remains unchanged.

From a legacy mobile device perspective, the only change in the burst structure is to the tail symbols. Thus, referring to FIG. 16B, a legacy mobile device will see a burst 1600 with essentially tail symbols (which may be different to the legacy tail symbols) 1614 and 1616 as well as data portions 1620 and 1624 and a training sequence 1630.

An SCE2 receiver will see the burst of FIG. 16C, which includes a cyclic prefix 1650 which is double the length of the cyclic prefix 1610. The cyclic prefix 1650 comes from a portion shown by arrow 1652.

Data portion 1620 and 1624 are shown along with training sequence 1630.

The burst format for a SCE2 (Type 2) normal burst is shown in Table 18 below.

TABLE 18
SCE2(Type 2-2) Normal Burst, 16 QAM

| | Length of field | |
|---|---|---|
| Bit Number (BN) | (bits) | Contents of field |
| 0-11 | 12 | cyclic prefix bits |
| 12-243 | 232 | encrypted bits (e0.e231) |
| 244-347 | 104 | training sequence bits |
| 348-579 | 232 | encrypted bits (e232.e463) |
| 580-591 | 12 | cyclic postfix bits |
| 592-624 | 33 | guard period |

From Table 18, the “training sequence bits” are defined as modulating bits with states as given in Table 19 according to the training sequence code, TSC. For BCCH and CCCH, the TSC must be equal to the BCC, as defined in 3GPP TS 23.003.

TABLE 19
Training Sequence Code

| Training | |
|---|---|
| Sequence Code | |
| (TSC) | Training sequence symbols (BN244, BN245 . . . BN347) |
| 0 | (1, 1, 1, 1; 1, 1, 1, 1; 0, 0, 1, 1; 1, 1, 1, 1; 1, 1, 1, 1; 0, 0, 1, 1; 1, 1, 1, 1; 0, 0, 1, 1; 0, 0, |
| | 1, 1; 0, 0, 1, 1; 1, 1, 1, 1; 1, 1, 1, 1; 1, 1, 1, 1; 1, 1, 1, 1; 0, 0, 1, 1; 1, 1, 1, 1; 1, 1, 1, 1; |
| | 1, 1, 1, 1; 0, 0, 1, 1; 1, 1, 1, 1; 1, 1, 1, 1; 0, 0, 1, 1; 1, 1, 1, 1; 0, 0, 1, 1; 0, 0, 1, 1; 0, 0, |
| | 1, 1) |
| 1 | (1, 1, 1, 1; 1, 1, 1, 1; 0, 0, 1, 1; 1, 1, 1, 1; 0, 0, 1, 1; 0, 0, 1, 1; 1, 1, 1, 1; 0, 0, 1, 1; 0, 0, |
| | 1, 1; 0, 0, 1, 1; 1, 1, 1, 1; 0, 0, 1, 1; 0, 0, 1, 1; 0, 0, 1, 1; 0, 0, 1, 1; 1, 1, 1, 1; 1, 1, 1, 1; |
| | 1, 1, 1, 1; 0, 0, 1, 1; 1, 1, 1, 1; 0, 0, 1, 1; 0, 0, 1, 1; 1, 1, 1, 1; 0, 0, 1, 1; 0, 0, 1, 1; 0, 0, |
| | 1, 1) |
| 2 | (1, 1, 1, 1; 0, 0, 1, 1; 1, 1, 1, 1; 1, 1, 1, 1; 1, 1, 1, 1; 1, 1, 1, 1; 0, 0, 1, 1; 0, 0, 1, 1; 0, 0, |
| | 1, 1; 1, 1, 1, 1; 0, 0, 1, 1; 0, 0, 1, 1; 0, 0, 1, 1; 1, 1, 1, 1; 0, 0, 1, 1; 1, 1, 1, 1; 1, 1, 1, 1; |
| | 0, 0, 1, 1; 1, 1, 1, 1; 1, 1, 1, 1; 1, 1, 1, 1; 1, 1, 1, 1; 0, 0, 1, 1; 0, 0, 1, 1; 0, 0, 1, 1; 1, 1, |
| | 1, 1) |
| 3 | (1, 1, 1, 1; 0, 0, 1, 1; 1, 1, 1, 1; 1, 1, 1, 1; 1, 1, 1, 1; 0, 0, 1, 1; 0, 0, 1, 1; 0, 0, 1, 1; 0, 0, |
| | 1, 1; 1, 1, 1, 1; 0, 0, 1, 1; 0, 0, 1, 1; 1, 1, 1, 1; 0, 0, 1, 1; 1, 1, 1, 1; 1, 1, 1, 1; 1, 1, 1, 1; |
| | 0, 0, 1, 1; 1, 1, 1, 1; 1, 1, 1, 1; 1, 1, 1, 1; 0, 0, 1, 1; 0, 0, 1, 1; 0, 0, 1, 1; 0, 0, 1, 1; 1, 1, |
| | 1, 1) |
| 4 | (1, 1, 1, 1; 1, 1, 1, 1; 1, 1, 1, 1; 0, 0, 1, 1; 0, 0, 1, 1; 1, 1, 1, 1; 0, 0, 1, 1; 1, 1, 1, 1; 0, 0, |
| | 1, 1; 0, 0, 1, 1; 0, 0, 1, 1; 1, 1, 1, 1; 1, 1, 1, 1; 0, 0, 1, 1; 1, 1, 1, 1; 1, 1, 1, 1; 1, 1, 1, 1; |
| | 1, 1, 1, 1; 1, 1, 1, 1; 0, 0, 1, 1; 0, 0, 1, 1; 1, 1, 1, 1; 0, 0, 1, 1; 1, 1, 1, 1; 0, 0, 1, 1; 0, 0, |
| | 1, 1) |
| 5 | (1, 1, 1, 1; 0, 0, 1, 1; 1, 1, 1, 1; 1, 1, 1, 1; 0, 0, 1, 1; 0, 0, 1, 1; 0, 0, 1, 1; 1, 1, 1, 1; 0, 0, |
| | 1, 1; 1, 1, 1, 1; 0, 0, 1, 1; 0, 0, 1, 1; 1, 1, 1, 1; 1, 1, 1, 1; 1, 1, 1, 1; 1, 1, 1, 1; 1, 1, 1, 1; |
| | 0, 0, 1, 1; 1, 1, 1, 1; 1, 1, 1, 1; 0, 0, 1, 1; 0, 0, 1, 1; 0, 0, 1, 1; 1, 1, 1, 1; 0, 0, 1, 1; 1, 1, |
| | 1, 1) |
| 6 | (0, 0, 1, 1; 1, 1, 1, 1; 0, 0, 1, 1; 1, 1, 1, 1; 1, 1, 1, 1; 0, 0, 1, 1; 0, 0, 1, 1; 0, 0, 1, 1; 0, 0, |
| | 1, 1; 0, 0, 1, 1; 1, 1, 1, 1; 0, 0, 1, 1; 0, 0, 1, 1; 1, 1, 1, 1; 1, 1, 1, 1; 1, 1, 1, 1; 0, 0, 1, 1; |
| | 1, 1, 1, 1; 0, 0, 1, 1; 1, 1, 1, 1; 1, 1, 1, 1; 0, 0, 1, 1; 0, 0, 1, 1; 0, 0, 1, 1; 0, 0, 1, 1; 0, 0, |
| | 1, 1) |
| 7 | (0, 0, 1, 1; 0, 0, 1, 1; 0, 0, 1, 1; 1, 1, 1, 1; 0, 0, 1, 1; 0, 0, 1, 1; 0, 0, 1, 1; 0, 0, 1, 1; 1, 1, |
| | 1, 1; 1, 1, 1, 1; 1, 1, 1, 1; 0, 0, 1, 1; 1, 1, 1, 1; 1, 1, 1, 1; 0, 0, 1, 1; 1, 1, 1, 1; 0, 0, 1, 1; |
| | 0, 0, 1, 1; 0, 0, 1, 1; 1, 1, 1, 1; 0, 0, 1, 1; 0, 0, 1, 1; 0, 0, 1, 1; 0, 0, 1, 1; 1, 1, 1, 1; 1, 1, |
| | 1, 1) |

From the above, the “cyclic prefix bits” are defined as modulating bits with states as follows: (BN0, BN1 . . . BN11)=(BN568, BN569, . . . , BN579) and the “cyclic postfix bits” are defined as modulating bits with states as follows: (BN580, BN581 . . . BN591)=(BN12, BN13, . . . , BN23). Thus the cyclic prefix bits are the 12 bits at the end of the second data portion and the cyclic postfix bits are the 12 bits at the start of the first data portion.

Further, the technique of adding a cyclic prefix and postfix as illustrated above with regard to FIGS. 15A and 16A could further be applied to the burst format described in PCT Application No. PCT/US11/025608.

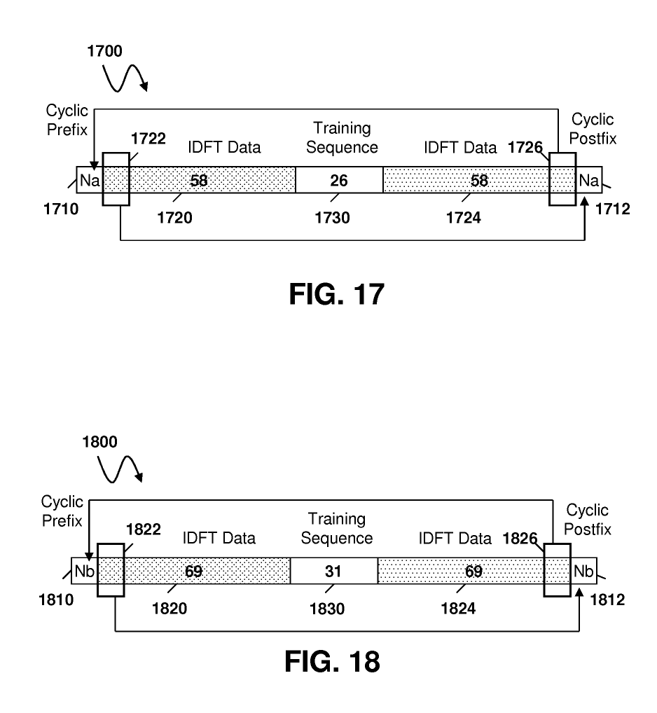

In particular, reference is now made to FIG. 17 which shows a variant of a PCE2-A based system where the IDFT precoded symbols are split into two parts and separated by a training sequence in the middle of the burst. The burst 1700 therefor has cyclic prefix 1710, first IDFT data portion 1720, second IDFT data portion 1724 and training sequence 1730 splitting first IDFT portion 1720 and second IDFT portion 1724. A cyclic postfix 1712 follows a second IDFT data portion 1724.

Utilizing the techniques above, a beginning part 1722 of first IDFT data portion 1720 is provided as cyclic postfix 1712. Similarly, an end portion 1726 of second IDFT data portion 1724 is provided as cyclic prefix 1710. The inserting of the cyclic prefix and cyclic postfix as shown in FIG. 17 results in an effective cyclic prefix length of twice Na without increasing the length of tail symbols.

Similarly for a PGE2-B burst reference is now made to FIG. 18. In FIG. 18 burst 1800 includes a first IDFT data portion 1820 and a second IDFT data portion 1824 separated by a training sequence 1830. Cyclic prefix 1810 is comprised of an end portion 1826 of second IDFT data portion 1824. Cyclic postfix 1812 is comprised of a beginning portion 1822 of first IDFT data portion 1820.

Transmitter for SCE2

A transmitter for an SCE2 burst has only one minor change compared to that of an EGPRS2 transmitter.

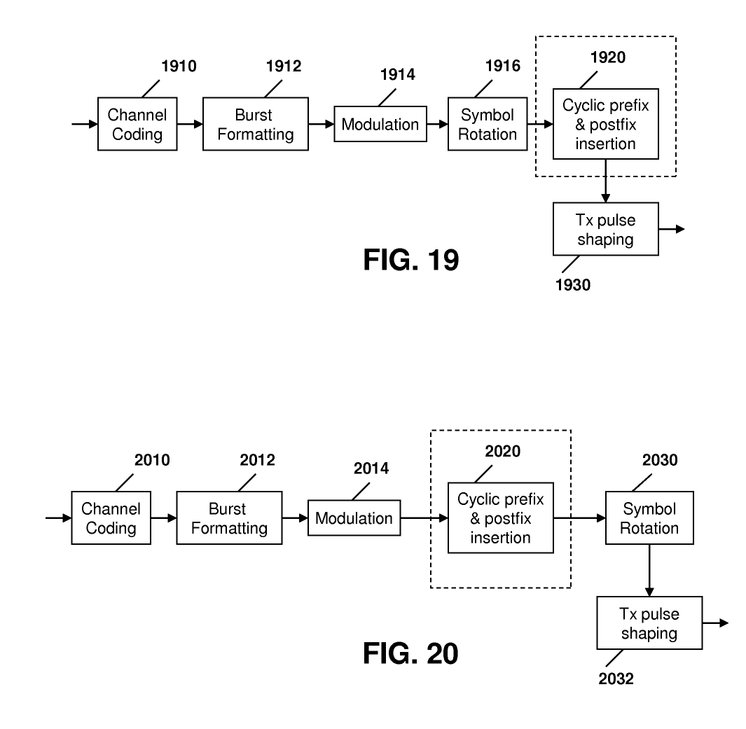

Reference is now made to FIG. 19. FIG. 19 shows an exemplary block diagram of an SCE2 transmitter. In particular, the embodiment of FIG. 19 has a channel coding block 1910 for FEC (forward error control) coding the data. A burst formatting block 1912 to perform burst formatting, modulation block 1914 for modulation of the signal.

Further, symbol rotation is then performed on the burst at block 1916.

The addition to the embodiment of FIG. 19 is the cyclic prefix and postfix insertion block 1920. As will be appreciated by those in the art having regard to the present disclosure, this box is new when compared with the EGPRS2 transmitter.

Once the cyclic prefix has been inserted the burst is then pulse shaped at block 1930 and is provided to a transmitter antenna.

Alternatively, the cyclic prefix and postfix insertion block may be placed before the symbol rotation. Reference is now made to FIG. 20. FIG. 20 shows a channel coding block 2010 followed by a burst formatting block 2012 followed by a modulation block 2014.

A cyclic prefix and postfix insertion block 2020 is provided after the modulation block 2014 and before a symbol rotation block 2030. The output from symbol rotation block 2030 is then pulse shaped at block 2032 before proceeding to a transmit antenna.

Based on FIGS. 19 and 20, the difference between an EGPRS2 transmitter and an SCE2 transmitter is that instead of inserting tail bits after modulation in EGPRS2, in SCE2 a cyclic prefix or postfix is added after modulation.

Thus, from the above, for SCE2 (Type 1), after modulation, the last symbols from the data, or symbols from the training sequence, are copied to the cyclic prefix and the first portion of the data or the last portion of the training sequence is copied to the postfix.

For SCE2-(Type 2-1), after modulation the last symbols of the second data area are copied and arranged in front of the first data portion as a cyclic prefix. The length of the cyclic prefix symbols is two times the training sequence in one embodiment.

For SCE2 (Type 2-2), after modulation, a last number of symbols of the second data area are copied and arranged in front of the first data area as a cyclic prefix and a first number of symbols of the first data area are copied and appended to the end of the second data area as a cyclic postfix.

The cyclic prefix length in SCE2 should be large enough to cover maximum channel delay.

The embodiments of FIGS. 19 and 20 are merely meant as examples and other embodiments of transmitters would be apparent to those in the art having regard to the present disclosure.

Based on the above, the embodiments of FIGS. 19 and 20 provide for a transmitter that is no more complex than that of an EGPRS2 transmitter and could thus be utilized with existing hardware for network operators.

Receiver

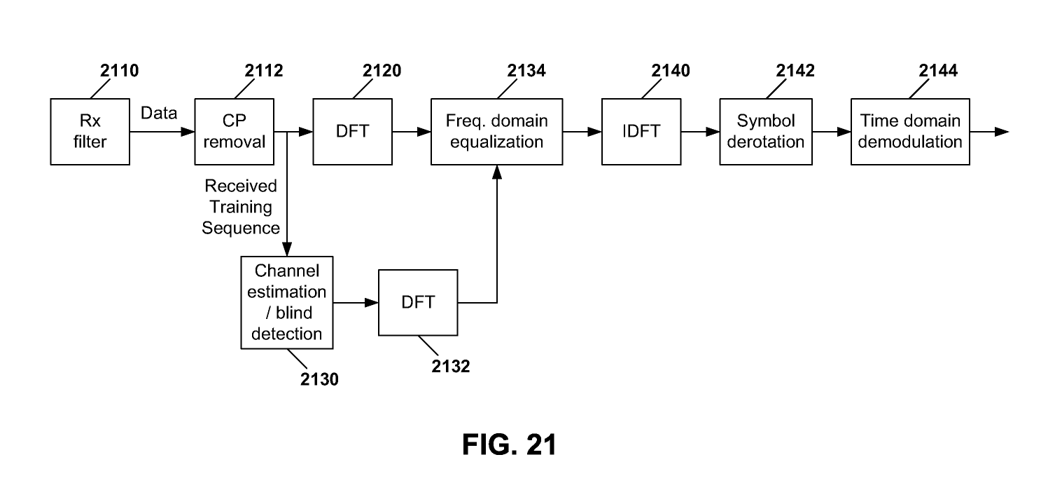

One exemplary receiver is shown with regard to FIG. 21. In FIG. 21, a receiver includes a receive filter 2110, along with a cyclic prefix removal block 2112.

After the cyclic prefix removal, the data portion of the received signal is provided to a Discrete Fourier Transform block 2120.

The received training sequence output from cyclic prefix removal block 2112 is further provided to a channel estimation/blind detection block 2130, whose output is then provided to a DFT block 2132.

The output from DFT blocks 2120 and 2132 is provided to a frequency domain equalization block 2134.

After frequency domain equalization, the signal is provided to an inverse Discrete Fourier Transform block 2140, which converts the signal back to the time domain.

Symbol de-rotation is then performed at block 2142 and a time domain de-modulation is performed at block 2144.

The above therefore provides for frequency domain equalization on a signal instead of performing the same equalization in the time domain. Frequency domain equalization may be implemented with lower complexity than a time domain equivalent especially for higher order modulations.

The receiver of FIG. 21 corresponds with the transmitter of FIG. 19.

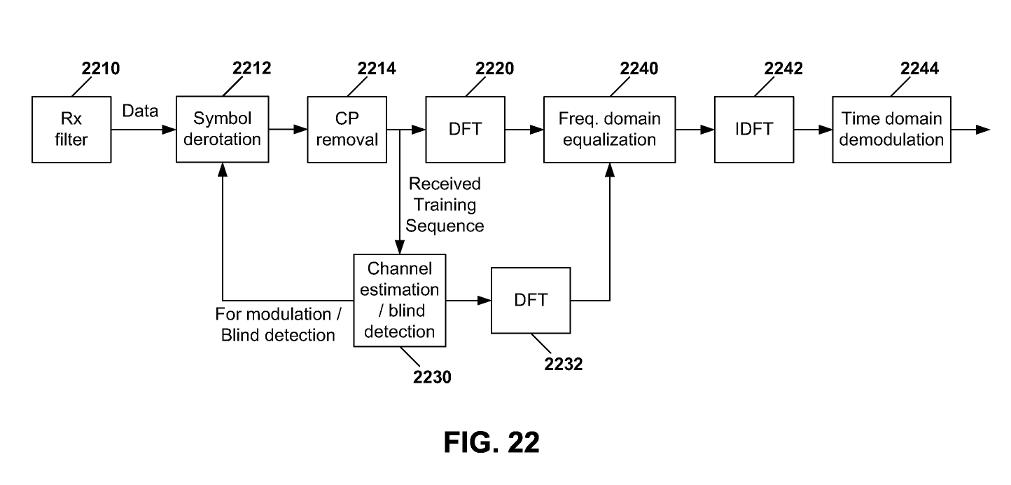

Conversely, if the transmitter of FIG. 20 is used, a receiver as shown in FIG. 22 may be utilized. In FIG. 22, a receive filter 2210 provides its output to a symbol de-rotation block 2212.

The output from symbol de-rotation block 2212 is provided to cyclic prefix removal block 2214.

The data from cyclic prefix removal block 2214 is provided to DFT block 2220. The received training sequence from CP removal block 2214 is provided to channel estimation and blind detection block 2230.

The output from channel estimation and blind detection block 2230 is provided back to symbol de-rotation block 2212 for modulation and blind detection. Further, the output from channel estimation and blind detection block 2230 is also provided to DFT block 2232.

Frequency domain equalization is performed at block 2240 based on inputs from DFT blocks 2220 and 2232.

The output from the frequency domain equalization is then converted at IDFT block 2242 and a time domain de-modulation occurs at block 2244.

Based on the above, the SCE2 format allows for frequency domain equalization.

While the embodiments of FIGS. 21 and 22 show receivers form SCE2, an SCE2 burst may also be received by a legacy EGPRS and EGPRS2 mobile device. Such a legacy mobile receiver can, in some embodiments, de-modulate the SCE2 burst as a normal EGPRS2 burst. The change between the SCE2 and the EGPRS2 burst is that the tail symbols are no longer there (or are different from what a legacy mobile may expect). This may only have a very negligible impact on the performance of the USF and PAN bits decoding or even data decoding on some legacy implementation. Further, any impact on decoding data would only exist if the SCE2 burst format is used to transmit data to legacy mobile devices. Until the time when there are no EGPRS2 mobiles in the field, it may still be possible to change the specifications for EGPRS2 mobiles such that the EGPRS2 burst formats are further modified and harmonized with some of the burst formats proposed for SCE2 by using the training sequence symbols as the tail symbols as described in SCE2 Type 1-2 or Type 1-3.

While the above indicates the transmitters may be at the network and the receivers may be at a mobile device, the present application is not limited to downlink transmission. In particular, unlike PCE2, the present SCE2 burst may be provided in the uplink. The same considerations as PCE2 with regard to the peak-to-average power ratios are not present with the SCE2 and therefore the mobile device transmitter could transmit an SCE2 burst in uplink direction. High peak to average power ration of the transmitted signal was one of the main reasons why PCE2 was not proposed for uplink.

A comparison of the formats and the size of the DFT are provided below with regard to Table 20. The sizes shown in Table 20 are all in symbols and assume that the CP length is equal to the tail symbol length. However, this is not limiting and other lengths for the cyclic prefix are possible. Other sizes for the CP may require the additional puncturing of data or extension to guard period.

TABLE 20
DFT sizes for bursts

| | Option | | |
|---|---|---|---|
| | shown in | DFT size | Effective CP length |
| SCE2-A | FIG. 7 | 58 | Na (Na = 3) |
| | FIG. 9 | 58 + Na | Na (=3) |
| | FIG. 11 | 58 + Na + x | Na (=3) |
| | FIG. 13 | 142 | 2xNa (=6) |
| | FIG. 15A | 142 | 2xNa (=6) |
| SCE2-B | FIG. 8 | 69 | Nb (Nb = 4) |
| | FIG. 10 | 69 + Nb | Nb (=4) |
| | FIG. 12 | 69 + Nb + y | Nb (=4) |
| | FIG. 14 | 169 | 2xNa (=8) |
| | FIG. 16A | 169 | 2xNa (=8) |

From Table 20, burst formats of Type 1 have smaller DFT lengths at the receiver compared to the burst formats of Type 2. The DFT length is inversely proportional to the effective subcarrier spacing in frequency domain and a smaller DFT length yields larger subcarrier spacing and this is known to provide more robustness against Doppler spread in the channel, which is better for mobile devices moving at higher speeds.

Burst formats of Type 2 on the other hand have a longer cyclic prefix, which may be better in channels having larger delay spread.

A transmitter may be able to switch between different burst formats based on mobile speeds or channel profile conditions. For instance for indoor/office coverage scenarios where the mobile device speeds are rather small, burst formats in Type 2 may be good. For cells where the delay spread is known to be small but with high mobile speeds (for example covering a motorway or a train track where there is more or less line of sight but the relative speed between base station and mobile is high), then burst formats in Type 1 can be used.

If more than one burst format is used, then the network may signal the format used. This may occur at the start of the call using an assignment message, or during the call if needed, for example.

Multiplexing Legacy Devices With SCE2 Mobiles

Several factors can exist to facilitate the multiplexing of legacy mobile devices with SCE2 mobile devices. A first is the capability of the network to support SCE2. A second is whether the SCE2-capable mobile device is able to decode the USF, PAN, or both, for data from legacy and SCE2 bursts. A third consideration is whether the legacy mobile device needs to be able to decode the USF, PAN, or both, and data from SCE2 bursts.

With regard to the capability, the capability of a network may be signaled to mobile devices.

System information sent on the broadcast control channel (BCCH) may indicate if SCE2 is supported by the network in a given cell. For example, this may be within the GPRS Cell Options Information Element (S113) sent on the BCCH. Separate indications may be broadcast for downlink and uplink directions.

An SCE2 capable mobile station may therefore know the SCE2 network capability by monitoring the BCCH, and, correspondingly, could either expect to receive SCE2 bursts in the downlink from the network or be allowed to send SCE2 bursts in uplink to the network, or both.

Alternatively, it may be necessary for the mobile to know whether or not SCE2 modes may be used during a given data session and this may be signaled using fields in the packet assignment messages. Signaling may be independent for downlink and uplink temporary block flows (TBFs). In the case of broadcast signaling of packet assignments, a broadcast would not be necessary in some embodiments.

Further the mobile device may signal its SCE2 capability. For example, a mobile device supporting an SCE2 may need to indicate its SCE2 capability to the network in the MS radio access capability information element (IE) as specified in 3GPP TS 24.008, the contents of which are incorporated herein by reference. Alternatively, for a dual transfer mode capable mobile station the signaling may be in the channel request description to an IE as specified in 3GPP TS 44.018, the contents of which are incorporation herein by reference. Such signaling avoids increasing unnecessarily the size of the mobile station class 3 information elements. Similar to EGPRS mobile station packet access procedures as described in 3GPP TS 44.018, the SCE2 mobile station or device may initialize the channel request by sending a CHANNEL REQUEST or an EGPRS PACKET CHANNEL REQUEST on the radio access channel (RACH).

From the above, the MS radio access capability is sent either to the base station subsystem (BSS) within the second phase of a two-phase uplink access, or to the core network within GMM procedures. The mobile device capability can then be used for downlink transfers. To allow the network to know the SCE2 capability of the mobile station in case of a one phase uplink access, the SCE2 capability may be indicated in the EGPRS PACKET CHANNEL REQUEST message itself. There are a number of code points within the EGPRS PACKET CHANNEL REQUEST message.

Further, uplink and downlink SCE2 capabilities may be independent and may be signaled separately.

Multiplexing SCE2 Mobiles

Various options exist for multiplexing. In a first case, all mobile devices that are multiplexed on a given time slot are SCE2 capable. In this case, the network simply uses SCE2 burst formats for all blocks using modulation schemes relevant for SCE2. Such modulation schemes are typically higher order modulation schemes such as 16 or 32 QAM. The blocks are sent in the downlink during the data session. The SCE2 mobile devices will then employ frequency domain equalization to decode the data and the USF, PAN, or both.

In a second case, at least one SCE2 mobile device is multiplexed with at least one legacy mobile on a given time slot. In a first option in this case, one of the SCE2 burst formats as described above may be used during downlink data transfers. Legacy mobiles are expected to decode both the data and the USF, PAN or both, from the SCE2 bursts with negligible performance impact. The SCE2 mobile devices can then use the frequency domain equalizer to decode the data and USF from the SCE2 bursts. This option provides maximum possible gains for SCE2 mobiles.

A second option for an SCE2 mobile multiplexed with at least one legacy mobile is to avoid an SCE2 burst when data is addressed to legacy mobiles. Then SCE2 mobiles will have to blindly detect whether or not SCE2 bursts are used in the downlink. One way for an SCE2 mobile to detect whether the burst is an SCE2 burst of an EGPRS2 burst is by correlating the start and end of the bursts to see if the cyclic prefix is used.

A second way to blindly detect whether an SCE2 burst is used is by trying to look for known tail sequences in a legacy burst. Since this may be done before equalization it may not be completely reliable. However, such detection can provide the mobile device with an indication of which kind of burst is used.

A third option for blind detection is to look for known cyclic prefix sequences in the case where the burst format utilizes the training sequence for the cyclic prefix.

Once the SCE2 mobile device detects an SCE2 burst, it can then use frequency domain equalization. Conversely, if a legacy EGPRS2 burst format is detected, the legacy time domain equalizer may be used to decode the legacy burst.

Further, new modulation schemes are possible for introduction in SCE2 bursts. For example, 64 QAM may be used.

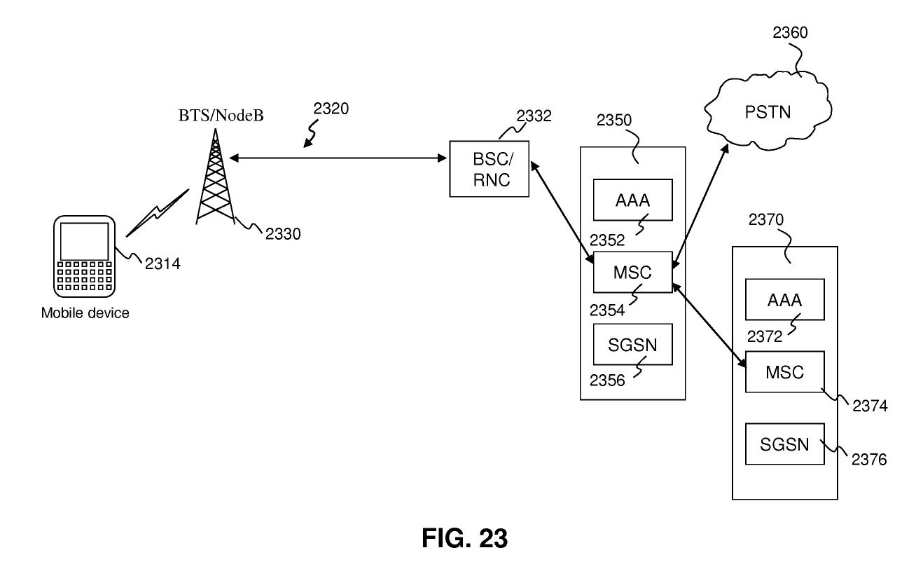

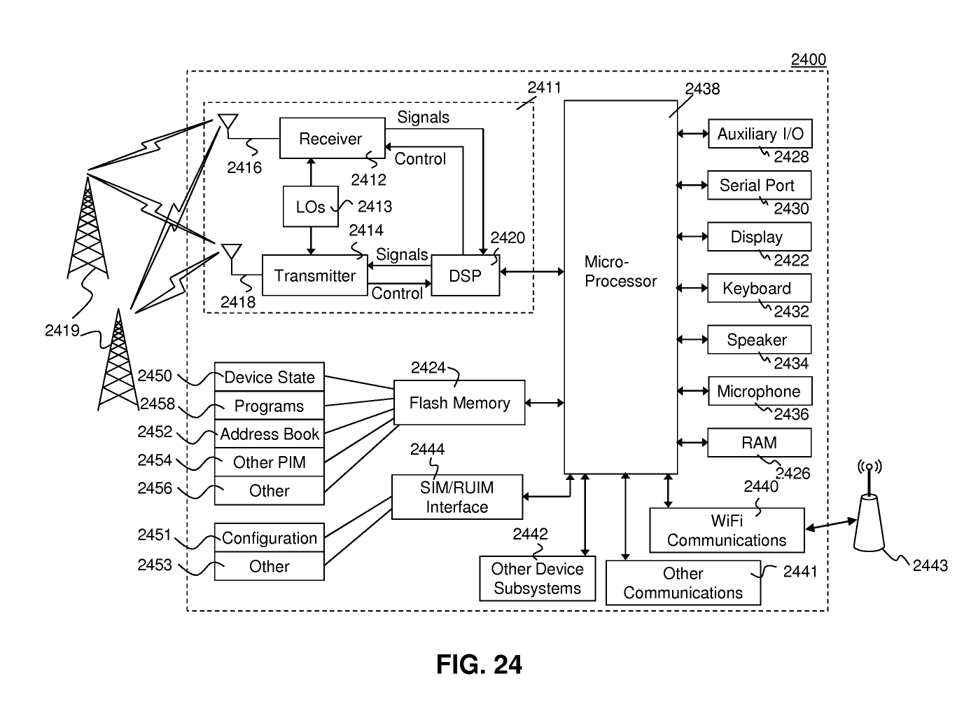

The methods and coding of FIGS. 1 to 22, can be performed by any network element. As used herein, a network element can be a network side server or a mobile device. Reference is now made to FIGS. 23 and 24, which show exemplary network and mobile device architectures.

FIG. 23 illustrates an architectural overview for an exemplary network. A mobile device 2314 is configured to communicate with cellular network 2320.

Mobile device 2314 may connect through cellular network 2320 to provide either voice or data services. As will be appreciated, various cellular networks exist, including, but not limited to, global system for mobile communication (GSM), GPRS, EGPRS, EGPRS2, among others. These technologies allow the use of voice, data or both at one time.

Cellular network 2320 comprises a base transceiver station (BTS)/Node B 2330 which communicates with a base station controller (BSC)/Radio Network Controller (RNC) 2332. BSC/RNC 2332 can access the mobile core network 2350 through either the mobile switching center (MSC) 2354 or the serving GPRS switching node (SGSN) 2356. MSC 2354 is utilized for circuit switched calls and SGSN 2356 is utilized for data packet transfer. As will be appreciated, these elements are GSM/UMTS specific, but similar elements exist in other types of cellular networks.

Core network 2350 further includes an authentication, authorization and accounting module 2352 and can further include items such as a home location registry (HLR) or visitor location registry (VLR).

MSC 2354 connects to a public switched telephone network (PSTN) 2360 for circuit switched calls. Alternatively, for mobile-to-mobile calls the MSC 2354 may connect to an MSC 2374 of core network 2370. Core network 2370 similarly has an authentication, authorization and accounting module 2372 and SGSN 2376. MSC 2374 could connect to a second mobile device through a base station controller/node B or an access point (not shown). In a further alternative embodiment, MSC 2354 may be the MSC for both mobile devices on a mobile-to-mobile call.

In accordance with the present disclosure, any network element, including mobile device 2314, BTS 2330, BSC 2332, MSC 2352, and SGSN 2356 could be used to perform the methods and encoding/decoding of FIGS. 1 to 22. In general, such network element will include a communications subsystem to communicate with other network elements, a processor and memory which interact and cooperate to perform the functionality of the network element.

Further, if the network element is a mobile device, any mobile device may be used. One exemplary mobile device is described below with reference to FIG. 24. The use of the mobile device of FIG. 24 is not meant to be limiting, but is provided for illustrative purposes.

Mobile device 2400 is a two-way wireless communication device having voice communication capabilities, data communication capabilities, or both. Depending on the exact functionality provided, the wireless device may be referred to as a data messaging device, a two-way pager, a wireless e-mail device, a cellular telephone with data messaging capabilities, a wireless Internet appliance, or a data communication device, as examples.

Where mobile device 2400 is enabled for two-way communication, it can incorporate a communication subsystem 2411, including both a receiver 2412 and a transmitter 2414, as well as associated components such as one or more, antenna elements 2416 and 2418, local oscillators (LOs) 2413, and a processing module such as a digital signal processor (DSP) 2420 The particular design of the communication subsystem 2411 depends upon the communication network in which the device is intended to operate.

When required network registration or activation procedures have been completed, mobile device 2400 may send and receive communication signals over the network 2419. As illustrated in FIG. 24, network 2419 can comprise of multiple base stations communicating with the mobile device.

Signals received by antenna 2416 through communication network 2419 are input to receiver 2412, which may perform such common receiver functions as signal amplification, frequency down conversion, filtering, channel selection and the like, and in the example system shown in FIG. 24, analog to digital (A/D) conversion. A/D conversion of a received signal allows more complex communication functions such as demodulation and decoding to be performed in the DSP 2420. In a similar manner, signals to be transmitted are processed, including modulation and encoding for example, by DSP 2420 and input to transmitter 2414 for digital to analog conversion, frequency up conversion, filtering, amplification and transmission over the communication network 2419 via antenna 2418. DSP 2420 not only processes communication signals, but also provides for receiver and transmitter control. For example, the gains applied to communication signals in receiver 2412 and transmitter 2414 may be adaptively controlled through automatic gain control algorithms implemented in DSP 2420.

Network access requirements will also vary depending upon the type of network 2419. In some networks network access is associated with a subscriber or user of mobile device 2400. A mobile device may require a removable user identity module (RUIM) or a subscriber identity module (SIM) card in order to operate on a network. The SIM/RUIM interface 2444 is normally similar to a card-slot into which a SIM/RUIM card can be inserted and ejected. The SIM/RUIM card may hold many key configurations 2451, and other information 2453 such as identification, and subscriber related information.

Mobile device 2400 includes a processor 2438 which controls the overall operation of the device. Communication functions, including at least data and voice communications, are performed through communication subsystem 2411. Processor 2438 also interacts with further device subsystems such as the display 2422, flash memory 2424, random access memory (RAM) 2426, auxiliary input/output (I/O) subsystems 2428, serial port 2430, one or more, physical or virtual, keyboards or keypads 2432, speaker 2434, microphone 2436, other communication subsystem 2440 such as a short-range communications subsystem and any other device subsystems generally designated as 2442. Serial port 2430 could include a USB port or other port known to those in the art.

Some of the subsystems shown in FIG. 24 perform communication-related functions, whereas other subsystems may provide “resident” or on-device functions. Notably, some subsystems, such as keyboard 2432 and display 2422, for example, may be used for both communication-related functions, such as entering a text message for transmission over a communication network, and device-resident functions such as a calculator or task list.

Operating system software used by the processor 2438 can be stored in a persistent store such as flash memory 2424, which may instead be a read-only memory (ROM) or similar storage element (not shown). Specific device applications, or parts thereof, may be temporarily loaded into a volatile memory such as RAM 2426. Received communication signals may also be stored in RAM 2426.

As shown, flash memory 2424 can be segregated into different areas for both computer programs 2458 and program data storage 2450, 2452, 2454 and 2456. These different storage types indicate each program can allocate a portion of flash memory 2424 for their own data storage requirements. Processor 2438, in addition to its operating system functions, can enable execution of software applications on the mobile device. A predetermined set of applications which control basic operations, including data and voice communication applications for example, will normally be installed on mobile device 2400 during manufacturing. Other applications could be installed subsequently or dynamically.

A software application may be a personal information manager (PIM) application having the ability to organize and manage data items relating to the user of the mobile device such as, but not limited to, e-mail, calendar events, voice mails, appointments, and task items. Other applications for communication, multimedia, social networking, among others may be on mobile device 2400.

In a data communication mode, a received signal such as a text message or web page download will be processed by the communication subsystem 2411 and input to the microprocessor 2438, which further processes the received signal for element attributes for output to the display 2422, or alternatively to an auxiliary I/O device 2428.

A user of mobile device 2400 may also compose data items such as email messages for example, using the keyboard 2432, which can be a complete alphanumeric keyboard or telephone-type keypad in some embodiments, or a virtual keyboard in some embodiments, and used in conjunction with the display 2422 and possibly an auxiliary I/O device 2428. Such composed items may then be transmitted over a communication network through the communication subsystem 2411.

For voice communications, overall operation of mobile device 2400 is similar, except that received signals would be output to a speaker 2434 and signals for transmission would be generated by a microphone 2436. Alternative voice or audio I/O subsystems, such as a voice message recording subsystem, may also be implemented on mobile device 2400. Although voice or audio signal output is accomplished primarily through the speaker 2434, display 2422 may also be used to provide an indication of the identity of a calling party, the duration of a voice call, or other voice call related information for example.

Serial port 2430 in FIG. 24 would normally be implemented in a personal digital assistant (PDA)-type mobile device for which synchronization with a user's desktop computer (not shown) may be desirable, but is an optional device component. Such a port 2430 would enable a user to set preferences through an external device or software application and would extend the capabilities of mobile device 2400 by providing for information or software downloads to mobile device 2400 other than through a wireless communication network. The alternate download path may for example be used to load an encryption key onto the device through a direct and thus reliable and trusted connection to thereby enable secure device communication. Serial port 2430 can further be used to connect the mobile device to a computer to act as a modem.

WiFi Communications Subsystem 2440 is used for WiFi Communications and can provide for communication with access point 2443.

Other communications subsystem(s) 2441, such as a short-range communications subsystem, are further components that may provide for communication between mobile device 2400 and different systems or devices, which need not necessarily be similar devices. For example, the subsystem(s) 2441 may include an infrared device and associated circuits and components or a Bluetooth™ communication module or a Near Field Communications module to provide for communication with similarly enabled systems and devices.

The embodiments described herein are examples of structures, systems or methods having elements corresponding to elements of the techniques of the present application. The above written description may enable those skilled in the art to make and use embodiments having alternative elements that likewise correspond to the elements of the techniques of the present application. The intended scope of the techniques of the above application thus includes other structures, systems or methods that do not differ from the techniques of the present application as described herein, and further includes other structures, systems or methods with insubstantial differences from the techniques of the present application as described herein.

1. A method comprising:
generating, at a transmitter, a burst containing a first data portion and a second data portion surrounding a training sequence; and
appending to the burst a cyclic prefix and a cyclic postfix.

2. The method of claim 1, wherein the cyclic prefix is selected from symbols at the end of the first data portion and the cyclic postfix is selected from symbols at the beginning of the second data portion.

3. The method of claim 2, wherein a number of symbols selected corresponds with a tail symbol length for at least one of a general packet radio service, an enhanced general packet radio service, or an evolved enhanced general packet radio service burst.

4. The method of claim 1, wherein the cyclic prefix is selected from symbols at the beginning of the training sequence and the cyclic postfix is selected from symbols at the end of the training sequence.

5. The method of claim 1, wherein the cyclic prefix is selected from symbols offset from the beginning of the training sequence and the cyclic postfix is selected from symbols offset from the end of the training sequence.

6. The method of claim 5, wherein the size of the offset is selected to create a total number of symbols for a discrete Fourier transform at the receiver with a small radix number.

7. The method of claim 1, wherein the cyclic postfix is omitted and the cyclic prefix is selected from symbols at the end of the second data portion.

8. The method of claim 7, wherein a number of symbols selected corresponds with twice a tail symbol length for at least one of a general packet radio service, an enhanced general packet radio service, or an evolved enhanced general packet radio service burst.

9. The method of claim 1, wherein the cyclic prefix is selected from symbols at the end of the second data portion and the cyclic postfix is selected from symbols at the beginning of the first data portion.

10. The method of claim 1, wherein the first data portion, training sequence, and second data portion correspond with a first data portion, training sequence and second data portion of an evolved, enhanced general packet radio service burst.

11. The method of claim 1, wherein the cyclic prefix and postfix are extended to a guard period of the burst.

12. The method of claim 1, further comprising:
if at least one receiver multiplexed on a packet data channel supports the burst format, using the burst format for all receivers multiplexed on the packet data channel.

13. The method of claim 1, further comprising:
if at least one receiver multiplexed on a packet data channel supports the burst format, using the burst format for the bursts in which the data is addressed to the said at least one receiver.

14. The method of claim 1, further comprising:
choosing a burst format based on channel conditions, the burst format having a cyclic prefix and cyclic postfix selected from any one of:
the cyclic prefix is selected from symbols at the end of the first data portion and the cyclic postfix is selected from symbols at the beginning of the second data portion;
the cyclic prefix is selected from symbols at the beginning of the training sequence and the cyclic postfix is selected from symbols at the end of the training sequence;
the cyclic prefix is selected from symbols offset from the beginning of the training sequence and the cyclic postfix is selected from symbols offset from the end of the training sequence;
the cyclic postfix is omitted and the cyclic prefix is selected from symbols at the end of the second data portion; or
the cyclic prefix is selected from symbols at the end of the second data portion and the cyclic postfix is selected from symbols at the beginning of the first data portion.

15. A transmitter comprising:
a processor; and
a communications subsystem, wherein the processor and communications subsystem cooperate to:
generate a burst containing a first data portion and a second data portion surrounding a training sequence; and
append to the burst a cyclic prefix and a cyclic postfix.

16. The transmitter of claim 15, wherein the cyclic prefix is selected from symbols at the end of the first data portion and the cyclic postfix is selected from symbols at the beginning of the second data portion.

17. The transmitter of claim 16, wherein a number of symbols selected corresponds with a tail symbol length for at least one of a general packet radio service, an enhanced general packet radio service, and an evolved enhanced general packet radio service burst.

18. The transmitter of claim 15, wherein the cyclic prefix is selected from symbols at the beginning of the training sequence and the cyclic postfix is selected from symbols at the end of the training sequence.

19. The transmitter of claim 15, wherein the cyclic prefix is selected from symbols offset from the beginning of the training sequence and the cyclic postfix is selected from symbols offset from the end of the training sequence.

20. The transmitter of claim 19, wherein the size of the offset is selected to create a total number of symbols for a discrete Fourier transform at the receiver with a small radix number.

21. The transmitter of claim 15, wherein the cyclic postfix is omitted and the cyclic prefix is selected from symbols at the end of the second data portion.

22. The transmitter of claim 21, wherein a number of symbols selected corresponds with twice a tail symbol length for at least one of a general packet radio service, an enhanced general packet radio service, and an evolved enhanced general packet radio service burst.

23. The transmitter of claim 15, wherein the cyclic prefix is selected from symbols at the end of the second data portion and the cyclic postfix is selected from symbols at the beginning of the first data portion.

24. The transmitter of claim 15, wherein the first data portion, training sequence, and second data portion correspond with a first data portion, training sequence and second data portion of an evolved, enhanced general packet radio service burst.

25. The transmitter of claim 15, wherein the processor and communications subsystem further cooperate to:
if at least one receiver multiplexed on a packet data channel supports the burst format, use the burst format for all receivers multiplexed on the packet data channel.

26. The transmitter of claim 15 wherein the processor and communications subsystem further cooperate to:
if at least one receiver multiplexed on a packet data channel supports the burst format, use the burst format for the bursts in which the data is addressed to the said at least one receiver.

27. The transmitter of claim 15, wherein the processor and communications subsystem further cooperate to:
choose a burst format based on channel conditions, the burst format having a cyclic prefix and cyclic postfix selected from any one of:
the cyclic prefix is selected from symbols at the end of the first data portion and the cyclic postfix is selected from symbols at the beginning of the second data portion;
the cyclic prefix is selected from symbols at the beginning of the training sequence and the cyclic postfix is selected from symbols at the end of the training sequence;
the cyclic prefix is selected from symbols offset from the beginning of the training sequence and the cyclic postfix is selected from symbols offset from the end of the training sequence;
the cyclic postfix is omitted and the cyclic prefix is selected from symbols at the end of the second data portion; or
the cyclic prefix is selected from symbols at the end of the second data portion and the cyclic postfix is selected from symbols at the beginning of the first data portion.

28. The transmitter of claim 15, wherein the cyclic prefix and postfix are extended to a guard period of the burst.

29. A method at a receiver comprising:
receiving a burst containing a cyclic prefix, a cyclic postfix and a data portion;
removing at least one of the cyclic prefix or the cyclic postfix;
transforming the data portion with a discrete Fourier transform;
estimating the modulation of the received burst and estimating the channel frequency response;
undoing an effect of a channel on the data portion by using the estimated channel frequency response of the channel on the transformed data;
using an inverse discrete Fourier transform on the result of the equalizing step; and
further processing the output of the equalization step to decode the transmitted bits.

30. A receiver on a network element, the receiver configured to:
receive a burst containing a cyclic prefix, a cyclic postfix and a data portion;
remove at least one of the cyclic prefix or the cyclic postfix;
transform the data portion with a discrete Fourier transform;
estimate the channel frequency response and modulation of the burst;
undo an effect of a channel on the data portion by using the estimated channel frequency response of the channel on the transformed data;
use an inverse discrete Fourier transform on the result of the equalizing step; and
further process the output of the equalization step to decode the transmitted bits.

31. A method comprising
generating, at a transmitter, a burst containing a plurality of inverse discrete Fourier transform ('IDFT') precoded symbols surrounding a plurality of non-IDFT precoded mid-amble symbols; and
adding a plurality of cyclic prefix symbols in front of the IDFT precoded symbols and a plurality of cyclic postfix symbols at an end of the IDFT precoded symbols,
wherein the cyclic prefix symbols are selected from the end of the IDFT precoded symbols and cyclic postfix symbols are selected from a beginning of the IDFT precoded symbols.

32. A transmitter comprising:
a processor; and
a communications subsystem, wherein the processor and communications subsystem cooperate to:
generate a burst containing a plurality of inverse discrete Fourier transform ('IDFT') precoded symbols surrounding a plurality of non-IDFT precoded mid-amble symbols; and
add a plurality of cyclic prefix symbols in front of the IDFT precoded symbols and a plurality of cyclic postfix symbols at an end of the IDFT precoded symbols, the cyclic prefix symbols being selected from the end of the IDFT precoded symbols and cyclic postfix symbols are selected from a beginning of the IDFT precoded symbols.
